(19) United States
(12) Patent Application Publication
(10) Pub. No.: US 2014/0257906 A1
(43) Pub. Date: Sep. 11, 2014

(54) Workflow Management Method and System

(71) Applicant: TRIMBLE NAVIGATION LIMITED, Sunnyvale, CA (US)

(72) Inventor: Omar Soubra, Westminster, CO (US)

(73) Assignee: TRIMBLE NAVIGATION LIMITED, Sunnyvale, CA (US)

(21) Appl. No.: 13/790,114

(22) Filed: Mar. 8, 2013

(51) Int. Cl. G06Q 10/10

(52) U.S. Cl. CPC G06Q 10/1097
USPC 705/7.21

(57) ABSTRACT

Novel tools and techniques are described for managing workflow for projects, including, without limitation, cadastral survey projects. In one aspect, a method might comprise providing a workflow management schedule to a user over a network from a remote computer system. The remote computer system might compare one or more workflow items—including one or more of a task, a meeting, a project, a deadline, a time, a date, one or locations, or required data—on the workflow management schedule with workflow items on reference schedules, and identifying one or more necessary workflow items not included on the workflow management schedule, based on the comparison. The remote computer system might add the one or more necessary workflow items to the workflow management schedule. The remote computer system might additionally define, and send to the user, a scope of work associated with each necessary workflow item, based on reference scopes of work.

### CROSS-REFERENCES TO RELATED APPLICATIONS

The present disclosure may be related to the following commonly assigned application(s)/patent(s):

U.S. patent application No. ______ filed on a date even herewith by Soubra et al. and titled “Image Identification Method and System” (attorney docket no. 0420.13), which is incorporated by reference herein in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, computer systems, and apparatuses for workflow management, and more particularly, to methods, computer systems, and apparatuses for workflow management in the course of cadastral surveys.

### BACKGROUND

A cadastre or cadastral survey is a public record, survey, or map of the value, extent, and ownership of land as a basis of taxation. Traditionally, cadastral surveys have been planned using schedules created, and confirmed, by cadastral workers. This requires that the cadastral worker compare, by hand or by personally reviewing, model schedules and model scopes of work with a workflow management schedule created by the cadastral worker for a particular cadastral survey project. This method, however, is time consuming and inefficient, and potentially fraught with errors.

Further, any later discovered deficiencies in the survey may require additional survey work and data gathering to be performed much later compared with the initial survey, perhaps weeks or months after the initial survey work and/or data gathering for a particular region. By that time, the cadastral field workers may have already moved on to a different region that may be many kilometers or miles away, such that recalling them to the original site might result in further delays in the overall project, might affect other present or future projects, or both.

As a result of the problems mentioned above, certain regions such as newly developed lands or recently developed lands are left without proper surveyed lands, giving rise to uncertainty as to value, extent, and ownership. Moreover, any deficiencies that are later discovered may compound the delay in establishing the cadastre for each plot of land in the region.

The embodiments disclosed herein are directed toward overcoming one or more of the problems discussed above.

### BRIEF SUMMARY

Various embodiments provide tools and techniques to enable management of workflow for projects, including without limitation cadastral survey projects.

According to some embodiments, a method might comprise providing a workflow management schedule to one or more user devices associated with one or more users, from a remote computer system over a network. The remote computer system might compare one or more workflow items on the workflow management schedule with workflow items on reference schedules, and identifying one or more necessary workflow items included in the reference schedules but not included on the workflow management schedule, based on the comparison. The one or more workflow items might include, but is not limited to, one or more of a task, a meeting, a project, a deadline, a time, a date, one or more locations, or required data. The remote computer system might add the one or more necessary workflow items to the workflow management schedule. In some embodiments, the workflow items being compared might include tasks and dates.

According to some embodiments, a workflow management application running on the remote computer system might additionally define, and send to the user, a scope of work associated with each necessary workflow item, based on reference scopes of work. The reference scopes of work might include, but is not limited to, a listing of the subtasks for the subject missing necessary task; a listing of personnel suggested for completion of the missing necessary task; a listing of materials, equipment, and/or services suggested for completion of the missing necessary task; a duration suggested for completion of the missing necessary task; or the like. In some embodiments, the scope of work might be defined by a separate scope of work calculation program, which might be running on the remote computer system or on a supplemental computer system remote from but in network communication with the remote computer system. In such cases, the workflow management application might send data associated with the workflow management schedule to the separate scope of work calculation program for calculating the scope of work associated with each necessary task.

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

In one aspect, a method might comprise providing to a user a workflow management schedule comprising one or more tasks and one or more dates for the initiation or completion of said tasks. The workflow management schedule may be provided from a computer system maintained by a service provider at a location which is remote from and in network communication with the user. The one or more tasks may be associated with the preparation of a cadastral survey. The method might further comprise comparing the tasks and the dates included on the workflow management schedule with reference tasks and reference dates included on at least one of multiple reference schedules. The comparing step may be performed with or using the remote computer system. According to some embodiments, the at least one of multiple reference schedules may be derived from prior cadastral survey projects and maintained by the service provider in a database including reference schedules.

The method might further comprise identifying, with the remote computer system, at least one necessary task and at least one necessary date not included on the workflow management schedule, from or based on at least one reference schedule. In some embodiments, the method might also comprise defining, with the remote computer system, a scope of work associated with the necessary task. The scope of work might comprise a listing of subtasks suggested for completion of the necessary task, a listing of personnel suggested for completion of the necessary task, a listing of materials, equipment, and services suggested for completion of the necessary task, and a duration suggested for completion of the necessary task. In some cases, the scope of work may be derived from scopes of work associated with prior cadastral survey projects and maintained by the service provider in a database including prior scopes of work. The method may further comprise adding, with the remote computer system, at least one necessary task, at least one necessary date, and at least one defined scope of work to the workflow management schedule.

According to some embodiments, the method might further comprise communicating the added at least one necessary task, the added at least one necessary date, and the added at least one defined scope of work from the remote computer system to one or more schedules maintained by one or more personnel suggested for completion of the necessary task. The method, in some embodiments, might also comprise communicating the listing of materials, equipment, and services suggested for completion of the necessary task from the remote computer system to one or more of a supplier of cadastral materials and equipment or a provider of services;

In some embodiments, the method might comprise receiving, at the remote computer system, an indication from the user that at least a portion of the necessary task is completed, and indicating on the workflow management schedule, with the remote computer system, the completion of at least a portion of the necessary task.

In another aspect, a method might comprise providing, with a computer system, a workflow management schedule including one or more workflow items. The method might further comprise comparing, with the computer system, the one or more workflow items included on the workflow management schedule with workflow items included on a reference schedule. In some embodiments, the method might further comprise identifying, with the computer system, a necessary workflow item included on the reference schedule not included on the workflow management schedule, and adding, with the computer system, the necessary workflow item to the workflow management schedule.

According to some embodiments, the one or more workflow items might comprise one or more of a task, a meeting, a project, a deadline, a time, a date, one or more locations, or required data. In some cases, at least one of the one or more workflow items might comprise a task associated with the preparation of a cadastral survey.

In some embodiments, the step of comparing the one or more workflow items included on the workflow management schedule with workflow items included on a reference schedule might comprise accessing, with the computer system, a database of reference schedules. The database of reference schedules might comprise reference schedules derived from one or more of prior projects or modeled schedules, and might comprise a remote database accessed by the computer system over a network.

The method, according to some embodiments, may further comprise defining, with the computer system, a scope of work associated with the necessary workflow item. In some embodiments, the step of defining the scope of work might comprise providing data associated with the workflow management schedule from the computer system to a separate scope calculation program configured to calculate a scope of work from the data, where the separate scope calculation program might be located remotely and may be accessed by the computer system over a network. According to some embodiments, the step of defining the scope of work might also comprise accessing, with the computer system, a database of reference scopes of work, where the reference scopes of work might be derived from one or more of prior projects or modeled scopes of work.

In some embodiments, the method might further comprise indicating on the workflow management schedule, with the computer system, the completion of at least a portion of the necessary workflow item.

In yet another aspect, a computer system might comprise a processor and a computer readable medium in communication with the processor. The computer readable medium might have encoded thereon a workflow management component to program the computer system to perform one or more operations, the workflow management component including a set of instructions executable by the processor. The set of instructions might comprise instructions for providing a workflow management schedule including one or more workflow items. The instructions might further comprise instructions for comparing the one or more workflow items included on the workflow management schedule with workflow items included on a reference schedule, and instructions for identifying a necessary workflow item included on the reference schedule not included on the workflow management schedule. The instructions might additionally comprise instructions for adding the necessary workflow item to the workflow management schedule.

In another aspect, an apparatus might comprise a non-transitory computer readable medium having encoded thereon a set of instructions executable by one or more computers to perform one or more operations. The set of instructions might comprise instructions for providing a workflow management schedule including one or more workflow items, and instructions for comparing the one or more workflow items included on the workflow management schedule with workflow items included on a reference schedule. The instructions might further comprise instructions for identifying a necessary workflow item included on the reference schedule not included on the workflow management schedule. The instructions might additionally comprise instructions for adding the necessary workflow item to the workflow management schedule.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a generalized system diagram illustrating an aspect of a system for performing workflow management, in accordance with various embodiments.

FIGS. 2A-2B are process flow diagrams illustrating aspects of a system for performing workflow management, in accordance with various embodiments.

FIGS. 3A-3B are flow charts illustrating exemplary processes for managing workflow, in accordance with various embodiments.

FIGS. 4A-4F represent a system flow diagram illustrating exemplary processes performed at or by components of a system in order to manage workflow, which can be used in accordance with various embodiments.

FIGS. 5A-5C represent an exemplary process of workflow management as performed by a workflow management application that is executed by a processor at a remote computer system, in accordance with various embodiments.

FIG. 6 is an exemplary graphical user interface for workflow management that is presented to a user, in accordance with various embodiments.

FIGS. 7A-7C are exemplary illustrations of mobile user devices used by users that present graphical user interfaces that incorporate workflow management, in accordance with various embodiments.

FIG. 8 is a block diagram illustrating an exemplary computer architecture, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Herein, the terms “cadastre” and “cadaster” are interchangeable, and refer to a public record, survey, or map of the value, extent, and ownership of a particular plot of land as a basis of taxation. The term “cadastral survey” refers to a survey conducted to establish a cadastre for a plot of land. The terms “reference schedule” and “model schedule” are interchangeable because reference schedules derived from prior projects and modeled schedules are, for purposes of the description below, functionally equivalent. Likewise, the terms “reference scopes of work” and “model scopes of work” are interchangeable because reference scopes of work derived from prior projects and modeled scopes of work are also, for purposes of the description below, functionally equivalent.

In addition, the terms “user computer” and “user device” are interchangeable, and refer to a user computer or device including, without limitation, a desktop or personal computer (“PC”), a laptop computer, a mobile device, and the like. The mobile device may include, but is not limited to, a tablet computer, a smart phone, and a mobile phone, etc. Further, a remote computer system, as described below, may comprise one or more remote computers, thus the terms “remote computer system,” “remote computer,” and “remote computers” are interchangeable.

A set of embodiments provides novel methods, computer systems, and apparatuses for managing workflow for cadastral survey projects. The disclosed methods, computer systems, and apparatuses can optionally be implemented in conjunction with the method and system for identification or recognition of objects, structures, landmarks, or persons in images for the purposes of establishing a cadastre for a plot of land amongst a plurality of plots of land in a region, as described in U.S. patent application No. ______ filed on a date even herewith by Soubra et al. and titled “Image Identification Method and System” (attorney docket no. 0420.13), which is incorporated by reference herein in its entirety.

In an aspect of some embodiments, exemplary methods, computer systems, and apparatuses are described. The exemplary methods, computer systems, and apparatuses might provide for managing workflow in a particular cadastral survey project. In some embodiments, a user might be provided, from a remote computer system, with a workflow management schedule for a particular cadastral survey project. The workflow management schedule, according to some embodiments, might be generated by the remote computer system based on (i) a model or reference workflow management schedule and/or (ii) input by the user. The input by the user might include, without limitation, input relating to major tasks to be completed, contractual deadlines, estimated deadlines, budget constraints, or the like.

In some embodiments, after providing the workflow management schedule, the remote computer system might compare the workflow management schedule with reference or model schedules that may be stored on one or more local databases, one or more remote databases, or both. In particular, the tasks and dates in the workflow management schedule may be compared with the reference tasks and reference dates, respectively, in the reference or model schedules. Based on this comparison, the remote computer system might identify at least one necessary task and at least one necessary date that are not included in the workflow management schedule.

According to some embodiments, the remote computer system may subsequently access and define a scope of work for the missing necessary task based on an analysis of reference or model scopes of work that may be stored on one or more local databases, one or more remote databases, or both. In some embodiments, the one or more local databases and the one or more remote databases might be the same or different databases as the databases on which the reference or model schedules might be stored. The model scopes of work might, in some examples, comprise a listing of the subtasks for the missing necessary task, a listing of personnel suggested for completion of the necessary task, a listing of materials, equipment, and/or services suggested for completion of the necessary task, a duration suggested for completion of the necessary task, or a combination of these components of the model scopes of work. In some embodiments, the reference scopes of work may be derived from scopes of work associated with prior cadastral survey projects and may be maintained by a service provider in a database including prior scopes of work. In other embodiments, the reference scopes of work may be derived by modeling scopes of work based on parameters shown to be associated with prior scopes of work, prior tasks, or both.

The remote computer, in some examples, may calculate or determine a necessary date for each missing necessary task based at least in part on the duration suggested for completion of the necessary task, and subsequently add each missing necessary task to the workflow management schedule, along with corresponding calculated necessary date and corresponding defined scope of work. In some embodiments, the remote computer system might send an updated workflow management schedule, as well as to any additional personnel who might be identified in the model scopes of work, thus replacing the existing workflow management schedule on the user devices. The updated workflow management schedule might comprise the one or more missing necessary tasks, the corresponding one or more necessary dates, and the corresponding one or more defined scopes of work. Such updating of the workflow management schedule may, in some examples, be performed by syncing each user computer or other user device associated with each user and any additional personnel. In other embodiments, the remote computer system might update portions of the workflow management schedule at the user computers or other user devices with the one or more missing necessary tasks, the corresponding one or more necessary dates, and the corresponding one or more defined scopes of work. Updating of the portions of the workflow management schedule may also be performed by syncing each user computer or other user device associated with each user and any additional personnel.

According to some embodiments, the remote computer system might automatically order any materials, equipment, and/or services that might be identified in the defined scopes of work. In cases where any of the sub-tasks, additional personnel, additional materials/equipment/services, duration of the necessary task, or any combination of these components might differ amongst the different scopes of work associated with the missing task, the remote computer might identify the best of these components of the scope of work. Such identification may be performed using any technique including, but not limited to, probability analysis, frequency determination, count determination, or the like, or any combination of techniques.

According to some embodiments, the remote computer system may wait to receive an indication from one or more of the user or any additional personnel that at least a portion of the missing necessary task is completed. In some embodiments, the remote computer system may also wait to receive an indication from one or more of the user or any additional personnel that at least a portion of any of the other tasks in the workflow management schedule is completed. The remote computer system may subsequently update the workflow management schedule with the indications of at least partial completion of each partially or fully completed task. As discussed above, the updated workflow management schedule might be sent to each user computer or user device associated with the user and any additional personnel, to replace the existing schedule. Alternatively, only the updated portions of the workflow management schedule may be sent to each user computer or user device associated with the user and any additional personnel, to replace only the corresponding portions of the workflow management schedule at each user computer or user device. According to some embodiments, both types of updates may be performed by syncing the user computers or user devices.

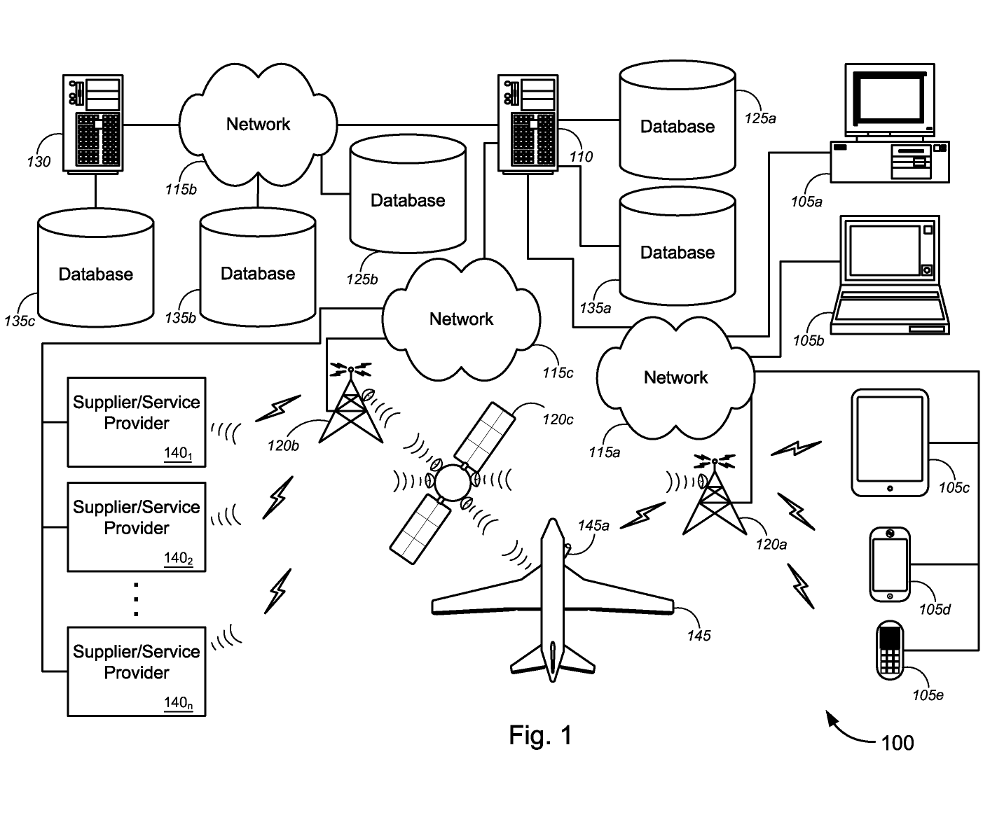

FIGS. 1-8 illustrate some of the features of the method and system for workflow management as referred to above. The methods and systems illustrated by FIGS. 1-8 refer to examples of different embodiments that include various components and steps, which can be considered alternatives or which can be used in conjunction with one another in the various embodiments. The description of the illustrated methods and systems shown in FIGS. 1-8 is provided for purposes of illustration and should not be considered to limit the scope of the different embodiments.

FIG. 1 is a generalized system diagram illustrating an aspect of a system 100 for performing workflow management. In FIG. 1, system 100 might comprise one or more user computers or user devices 105, one or more remote computer systems 110, one or more networks 115, one or more communications relay systems 120, one or more schedule databases 125, one or more supplemental computer systems 130, one or more scope of work databases 135, one or more suppliers/service providers 140, and an aircraft 145. Some of the above elements of the system 100 might be duplicated in alternative embodiments.

The one or more user devices 105, according to some embodiments, may include one or more of a desktop or PC 105a, a laptop computer 105b, a tablet computer 105c, a smart phone 105d, or a mobile phone 105e. The one or more user devices 105 might be communicatively coupled to the one or more remote computer systems 110 via network 115. Network 115 may be implemented as a combination of networks, including, but not limited to, the Internet, a public switched telephone network (“PSTN”), a private network, an Intranet, a local area network (“LAN”), a wide area network (“WAN”), and the like, perhaps via communications relay system 120, either via wireless connection or via wired connection.

The remote computer systems 110, according to some embodiments, might be maintained by a service provider, such as an Internet service provider, a telecommunications service provider, a data analysis service provider, etc. In other embodiments, the remote computer system 110 might be maintained at the company performing a particular project for which the workflow management is being implementing—including without limitation a cadastral survey project. In some embodiments, network 115 might include one or more of networks 115a, 115b, or 115c. Networks 115a, 115b, and 115c, according to some embodiments, may be separate networks, while in other embodiments, networks 115a, 115b, and 115c, or any pair of these networks, might be the same network. The one or more communications relay systems 120 might include, in some examples, one or more telecommunications towers (such as tower 120a and tower 120b), one or more satellites (such as satellite 120c), or a combination of towers and satellites.

In an exemplary implementation of a workflow management method or system as applied to cadastral survey work, user devices 105 may be coupled with the one or more remote computers 110, on which a workflow management application might be executed by a processor located therein. According to some embodiments, one or more user devices 105 might be located at a regional or national cadastral office, while one or more other user devices 105 might be located in the field for performing cadastral survey work. The workflow management application might provide each of the user devices 105—such as those associated with members of a cadastral survey team or other team, etc. —with a workflow management schedule. The workflow management schedule might, in some cases, be generated based on a model schedule, based on input by the users, or both. User input might include, without limitation, input relating to major tasks to be completed, contractual deadlines, estimated deadlines, budget constraints, or the like.

The workflow management application may, in some embodiments, access reference or model schedules stored on one or more schedule databases 125, and compare the tasks and dates in the workflow management schedule with reference tasks and reference dates stored on the one or more schedule databases 125. The one or more schedule databases 125 might include, for example, a local schedule database 125a, a remote schedule database 125b, or both. The remote schedule database 125b might, according to some embodiments, be connected to the remote computer system 110 via network 115b.

According to some embodiments, the workflow management application might identify one or more necessary tasks not included in the workflow management schedule (i.e., one or more missing necessary tasks), based on the comparison. The workflow management application, in some examples, might define a scope of work associated with each of the one or more missing necessary tasks, based on model or reference scopes of work stored on a scope of work database 135. The scope of work database 135 might include one or more of databases 135a, 135b, or 135c. In some cases, the workflow management application might access scopes of work stored on local scope of work database 135a or on remote scope of work database 135b, which might be accessible via network 115b. The defined scope of work associated with each missing necessary task might comprise, without limitation, a listing of the subtasks for the subject missing necessary task, a listing of personnel suggested for completion of the missing necessary task, a listing of materials, equipment, and/or services suggested for completion of the missing necessary task, a duration suggested for completion of the missing necessary task, or the like.

In some embodiments, a separate scope of work calculation program may be utilized to define the scope of work; such separate scope of work calculation program might be executed by a processor on a separate computer system. The separate computer system might include the one or more supplemental computer systems 130—to which database 135c might be a local scope of work database, while database 135b might be a remote scope of work database. Based on the suggested duration in the reference scope of work for each of the one or more necessary tasks, one or more necessary dates may be calculated, for example, by the workflow management application running on the remote computer 110 or by the separate scope of work calculation program running on supplemental computer 130. The one or more necessary dates might include, but is not limited to, a commencement or start date, a completion date, one or more milestone dates, one or more deadline dates for securing permits or other authorization, and the like. Subsequently, the one or more missing necessary tasks, the corresponding one or more necessary dates, and the corresponding defined scope of work may be sent to each user and to any suggested additional personnel, by sending to user device 105 associated with each user and to user devices 105 associated with any suggested additional personnel, respectively.

According to some embodiments, it may be determined—by the workflow management application, for example—that materials, equipment, and/or services may be required to complete the one or more missing necessary tasks. In such a case, the remote computer might communicate the listing of materials, equipment, and/or services to one or more suppliers/service providers 140 (including suppliers/service providers 140₁, 140₂, through 140ₙ) for providing the materials, equipment, and/or services to workers, locations, or workers and locations in the field. Such communication may be either via wired connection, or via wireless connection using network 115c and one or both of tower 120b and satellite 120c. In some embodiments, the service might include, without limitation, a service for obtaining aerial data, which might be performed by an aircraft 145 having camera 145a mounted thereon; a service for securing transportation for cadastral field workers, as well as the transportation services; a translation service, where necessary; a guide service, if necessary; a service for obtaining satellite imagery, data, or both; or the like. As shown in FIG. 1, for example, aircraft 145 might be in communication with remote computer 110 via communications relay systems 120, including, but not limited to, satellite 120c and towers 120a, 120b. Once each user reports that at least a portion of a task in the workflow management schedule—including existing tasks and originally missing (i.e., subsequently added) tasks—have been completed, then the workflow management schedule may be updated. Updating of the workflow management schedule may be performed either at the remote computer system 110 with the currently existing schedule at the corresponding user devices 105 being entirely replaced, or at the corresponding user device 105 with only the obsolete information being replaced.

According to some embodiments, the workflow management schedule might include one or more workflow items, each of which might include, without limitation, one or more of a task, a meeting, a project, a deadline, a time, a date, one or more work locations, or required data. In these embodiments, the workflow management application might compare the workflow items on the workflow management schedule with workflow items included on the reference schedule, identify necessary workflow items not included on the workflow management schedule (i.e., missing necessary workflow items) based on the comparison, and add the necessary (or missing) workflow items to the workflow management schedule. The workflow management method and system may otherwise be the same or similar to those as described above.

As mentioned above, system 100 can include one or more user computers 105. A user computer 105 can be a general purpose personal computer or PC—including, merely by way of example, desktop computers, tablet computers, laptop computers, handheld computers, and the like—running any appropriate operating system, a workstation computer running any of a variety of commercially-available operating systems, or a combination of computer types. In FIG. 1, user computer 105 is shown as including desktop or PC 105a and laptop computer 105b. User computer 105 may also include tablet computer 105c, any other mobile or personal communications device such as smartphone 105d or mobile phone 105e, or other hardware.

A user computer 105 can also store and/or execute any of a variety of applications, including one or more applications configured to perform operations in accordance with methods provided by various embodiments disclosed herein, as well as one or more office applications, database client or server applications, or web browser applications. Alternatively, a user computer 105 can be any other electronic device, such as a thin-client computer, Internet-enabled mobile telephone, and/or personal digital assistant, capable of any combination of communicating via a network, for example, the network 115 described herein, or displaying and navigating web pages or other types of electronic documents. Although the exemplary system 100 is shown with two user computers 105a, 105b and one tablet computer 105c, any number of user computers can be supported.

The network 115 can be any type of network familiar to those skilled in the art that can support data communications using any of a variety of commercially-available (and/or free or proprietary) protocols, including without limitation TCP/IP and the like. Merely by way of example, the network 115 can include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, any other wireless protocol, or any combination of protocols; or any combination of these or other networks. In some embodiments, networks 115a-115c, or any pair of these networks, may be embodied as one network.

Embodiments can also include one or more server computers 110 and/or 130. Each of the server computers 110 and 130 may be configured with an operating system, including without limitation any of those discussed above, as well as any commercially (or freely) available server operating systems. Each of the servers 110 and 130 may also be running one or more applications, which can be configured to provide services to one or more clients 105a-105e, or other servers 110 or 130.

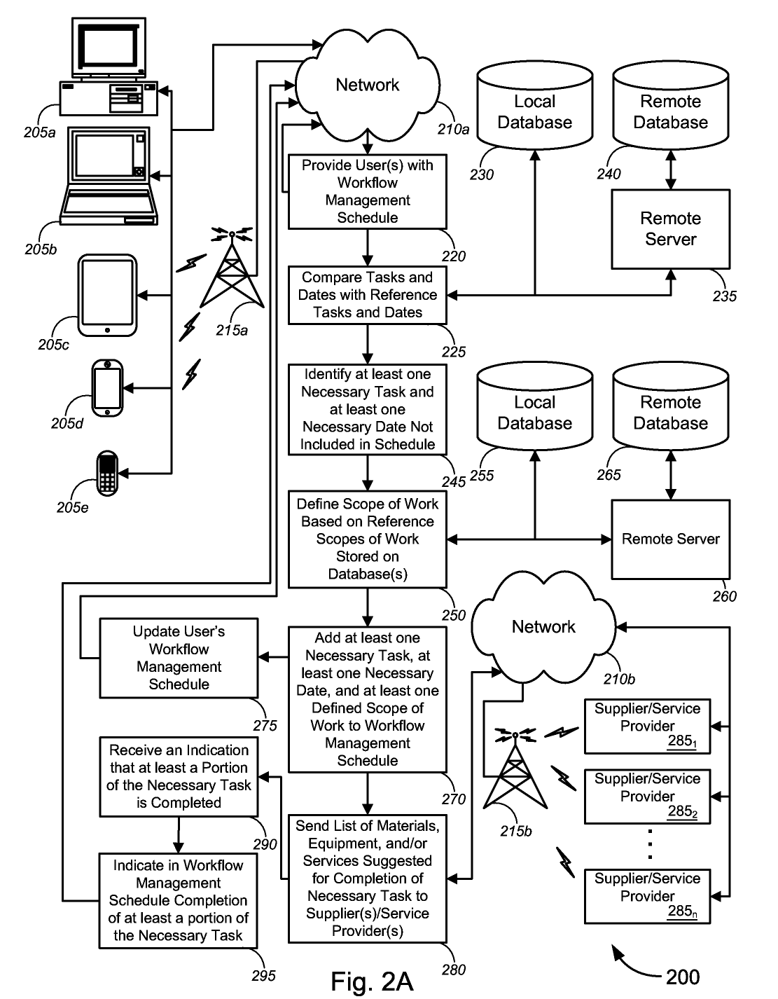

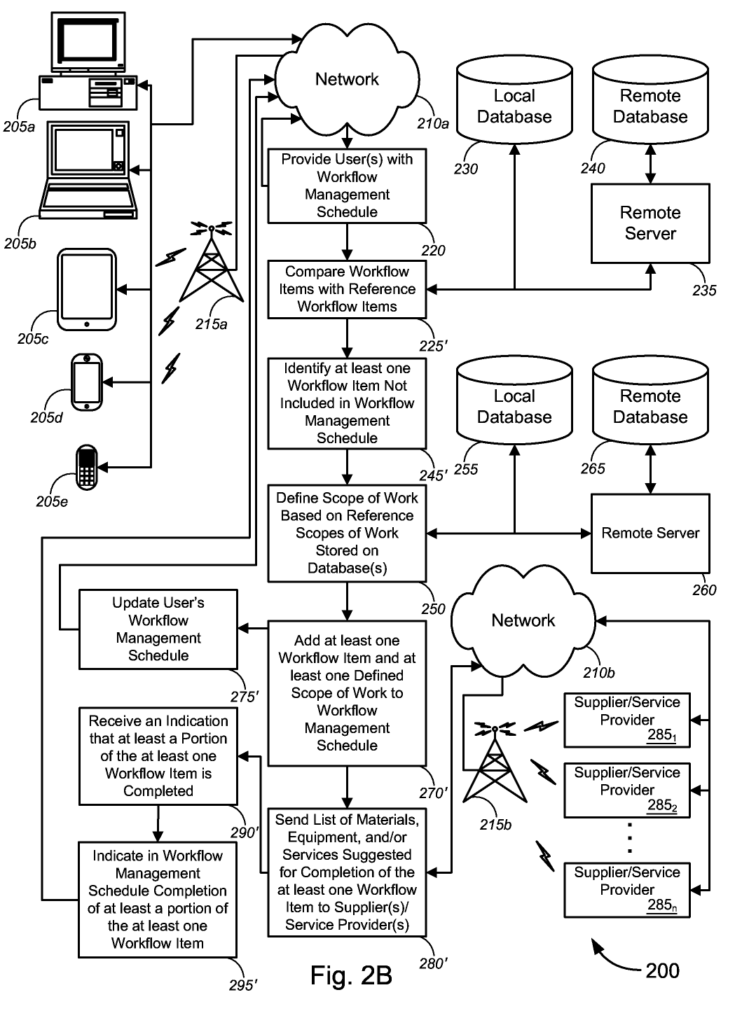

Merely by way of example, one or more of the servers 110 or 130 may be a web server, which can be used to process requests for web pages or other electronic documents from user computers 105a and 105b, or mobile devices 105c-105e. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 105a and 105b, or mobile devices 105c-105e to perform methods of the invention. The server 110 or 130 may also function as a middleware server that provides content. For example, as discussed in greater detail with respect to FIGS. 2A and 2B, middleware servers may include a server for accessing reference schedules, reference scopes of work, or both (e.g., module used in blocks 225, 250, 225′, and 250′), or a server functioning as a content catalog (e.g., remote servers 235 and 260), among other middleware servers. Some of the above-mentioned middleware servers may be embodied as one or more integrated or consolidated middleware servers that incorporate several functionalities into single servers. In addition, databases, including database 230, 240, 255, and 265, etc., may be embodied as middleware or database servers.

The server computer 110 or 130, in some embodiments, might include one or more application servers, which can be configured with one or more applications accessible by a client running on one or more of the client computers 105 and/or other servers 110 and 130. Merely by way of example, the server 110 or 130 can be one or more general purpose computers capable of executing programs or scripts in response to the user computers 105 and/or other servers 110 and 130. The programs or scripts may include without limitation web applications that, in some cases, might be configured to perform methods provided by various embodiments. Merely by way of example, a web application can be implemented as one or more scripts or programs written in any suitable programming language, including, but not limited to, Java™, C, C#™ or C++, or any scripting language, including, but not limited to, Perl, Python, or TCL, or any combination of programming or scripting languages. The application servers can also comprise database servers, including without limitation those commercially available from Oracle™, Microsoft™, Sybase™, IBM™, and the like. Such commercially available database servers might be capable of processing requests from clients—which might include, depending on the configuration, dedicated database clients, API clients, web browsers, etc. —running on a user computer 105 and/or another server 110 or 130. In some embodiments, an application server can create web pages dynamically for displaying the information in accordance with various embodiments, such as displaying workflow management screens for management workflow, displaying task screens for managing user tasks as part of the workflow management, and/or displaying work order screens for ordering work to be performed by one or more of various users, additional personnel, suppliers, or service providers, as one or more web pages. Data provided by an application server may be formatted as one or more web pages, which might comprise HTML, HTML5, JavaScript, etc., for example. In some cases, the data may be forwarded to a user computer 105 via a web server (as described above, for example). In other cases, the data may be formatted as one or more web pages and also forwarded to the user computer 105 or web server. Similarly, a web server might receive one or more of web page requests or input data from a user computer 105, or might forward the one or more of web page requests or input data to an application server, or both. In some cases, a web server may be integrated with an application server.

In accordance with further embodiments, one or more servers 110 or 130 can function as a file server, or can include one or more of the files (e.g., application code, data files, etc.) necessary to implement various disclosed methods. The one or more files may be incorporated by an application running on a user computer 105 and/or another server 110 or 130. Alternatively, a file server can include all necessary files, allowing such an application to be invoked remotely by one or more of a user computer 105 or a server 110 or 130.

It should be noted that the functions described with respect to various servers herein—including without limitation an application server, a database server, a web server, a file server, or the like—can be performed by a single server or a plurality of specialized servers, depending on implementation-specific needs and parameters.

In certain embodiments, the system can include one or more databases including, but not limited to, databases 230, 240, 255, and 265, as described in greater detail with respect to FIGS. 2A and 2B. The location of each database 125a, 125b, 135a-135c, 230, 240, 255, or 265 is discretionary. Merely by way of example, database 125a, 135a, 230, or 255 might reside on a storage medium local to, or might be resident in, a server 110. Alternatively, database 125b, 135b, 135c, 240, or 265 can be remote from any or all of the servers 110 and 130 or user computers 105, so long as it can be in communication (e.g., via the network 115 or similar network) with one or more of these servers/computers. In a particular set of embodiments, a database 125, 135, 230, 240, 255, or 265 can reside in a storage-area network (“SAN”). In one set of embodiments, the database 125, 135, 230, 240, 255, or 265 can be a relational database, such as an Oracle database, that is adapted to store, update, and retrieve data in response to SQL-formatted commands. The database might be controlled and/or maintained by a database server, as described above, for example.

Turning to FIGS. 2A and 2B (collectively, “FIG. 2”), FIGS. 2A-2B are process flow diagrams illustrating aspects of a system 200 for performing workflow management. In FIG. 2A, process 200 might comprise user devices 205 that may connect with a remote computer system via network 210a via a communications relay system 215. The user devices 205 may include one or more of a PC 205a, a laptop 205b, a tablet computer 205c, a smart phone 205d, or a mobile phone 205e. The remote computer system might include remote computer system 110, as shown in FIG. 1. The communications relay system 215 might include tower 215a, or any combination of towers 120a, 120b, and satellite 120c shown in FIG. 1.

At block 220, the remote computer system might provide the one or more user devices 205 with a workflow management schedule—which might be generated by a workflow management application running on the remote computer system, based on (i) a model or reference workflow management schedule and/or (ii) input by the user. The input by the user might include, but is not limited to, input relating to major tasks to be completed, contractual deadlines, estimated deadlines, budget constraints, or the like. The remote computer system, at block 225, might compare the tasks and dates in the workflow management schedule with reference tasks and reference dates in reference or model schedules that might be accessible from schedule databases (such as database 125, as shown in FIG. 1). In some embodiments, the remote computer system may access reference or model schedules stored on local database 230, while in other embodiments, the remote computer system might query remote server 235 to access reference or model schedules stored on remote database 240. According to some embodiments, the remote computer system might access reference or model schedules stored on both local database 230 and remote database 240. Comparison of the tasks and dates may be performed using any type of comparison technique—including, without limitation, keyword searching and matching, keyword mapping, document mapping and comparison, or the like, or any combination of techniques. At block 245, the remote computer system might identify at least one necessary task and at least one necessary date that are not included in the workflow management schedule, based on the comparison at block 225.

The remote computer system may, at block 250, define a scope of work associated with the at least one necessary task that is not included in the workflow management schedule, based on reference or model scopes of work stored on scope of work databases (such as databases 135, as shown in FIG. 1). The reference or model scope of work may comprise, among other information, a listing of the subtasks for the missing necessary task, a listing of personnel suggested for completion of the necessary task, a listing of materials, equipment, and/or services suggested for completion of the necessary task, a duration suggested for completion of the necessary task, and the like. In some embodiments, the remote computer system may access reference or model scopes of work stored on local database 255, while in other embodiments, the remote computer system might query remote server 260 to access reference or model scopes of work stored on remote database 265. According to some embodiments, the remote computer system might access reference or model schedules stored on both local database 255 and remote database 265. In defining the scope of work, the remote computer system might calculate the at least one necessary date by calculating based on the duration suggested for completion of the corresponding at least one necessary task, as indicated in the reference scopes of work associated with the corresponding at least one necessary task. The at least one necessary date might include, without limitation, one or more of a commencement or start date, a completion date, one or more milestone dates, one or more deadlines for securing permits or other authorization, or the like.

At block 270, the remote computer system might add the at least one necessary task, the corresponding at least one necessary date, and the corresponding at least one defined scope of work to the workflow management schedule, and update the workflow management schedule at the one or more user devices 205 (block 275). As described above, updating the workflow management schedule may be performed by syncing the one or more user devices 205, and by replacing a portion or the entire workflow management schedule on the one or more user devices 205.

Concurrent, or in sequence, with the updating process of block 275, the remote computer system, at block 280 may send to the appropriate suppliers and/or service providers 285, via network 210b and via tower 215b, a list of materials, equipment, and/or services suggested in the reference scopes of work for completion of the at least one necessary task. The appropriate suppliers, service providers, or both might include supplier/service provider 285₁, 285₂, through 285_{g}. According to some embodiments, the updating process of block 275 may precede the sending process of block 280, while in some other embodiments the sequence of the updating process of block 275 and sending process of block 280 may be reversed.

Subsequently, the remote computer system might wait until updates are provided by the one or more users and/or any additional personnel suggested for completion of the at least one necessary task. At block 290, the remote computer system might receive an indication from the one or more users and/or any additional personnel that at least a portion of the at least one necessary task, or any other tasks in the workflow management schedule, has been completed. The remote computer system might then indicate in the workflow management schedule—for example, by the updating methods described above—completion of at least a portion of the necessary task, or other tasks in the workflow management schedule.

FIG. 2B is similar to FIG. 2A, except that rather than comparing, identifying, and adding the at least one necessary task and at least one necessary date, the remote computer system might compare, identify, and add at least one workflow item. The at least one workflow item might include, without limitation, one or more of a task, a meeting, a project, a deadline, a time, a date, one or more work locations, or required data. Accordingly, at least blocks 225′, 245′, 270′ through 280′, 290′, and 295′ might reflect modification of blocks 225, 245, 270 through 280, 290, and 295, respectively, to expand at least one necessary task and at least one date to include at least one workflow item, as discussed above. Otherwise, the various steps in FIG. 2B are similar, if not identical to those in FIG. 2A, as described above.

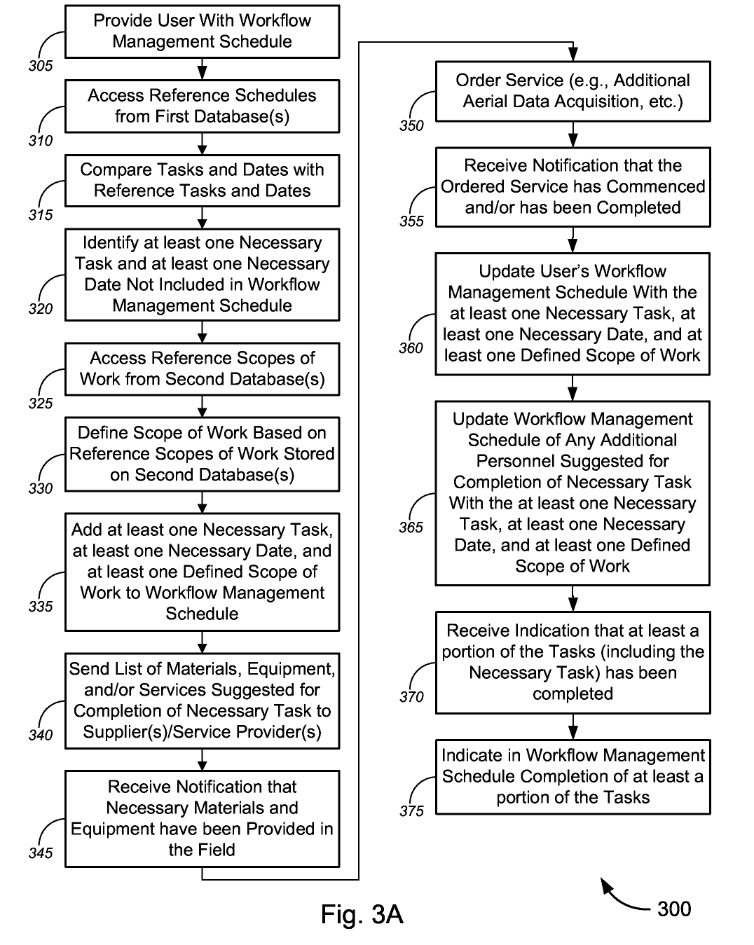

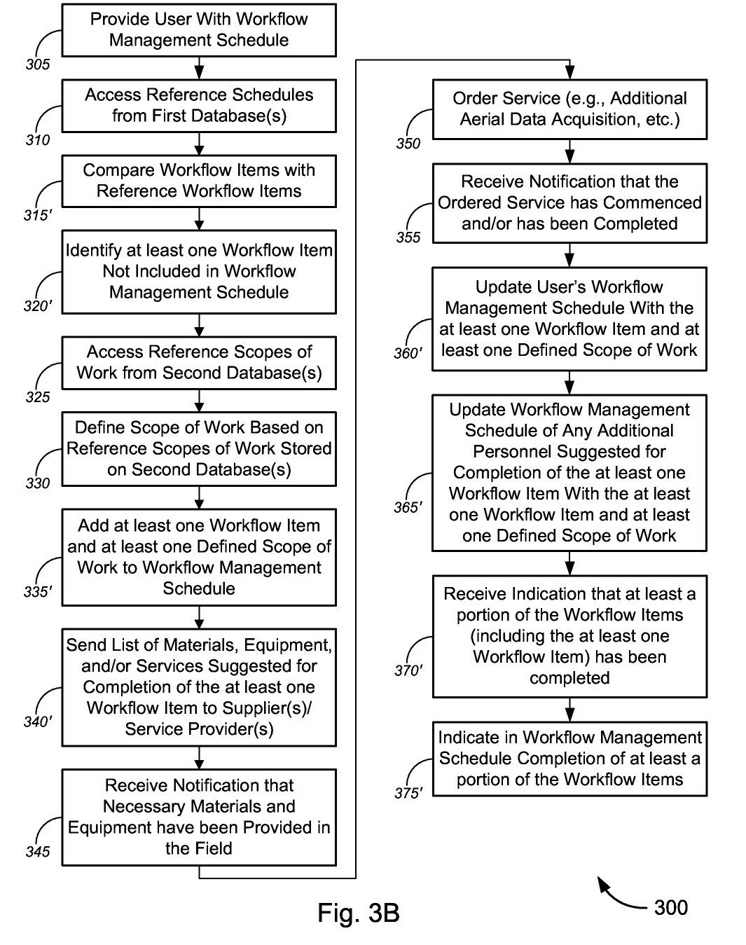

FIGS. 3A-3B (collectively, “FIG. 3”) are flow charts illustrating exemplary processes 300 for managing workflow. At block 305, process 300 might comprise providing, by the remote computer system, a workflow management schedule to a user, by sending the workflow management schedule to a user device that is associated with the user. The remote computer system might include, but is not limited to, remote computer system 110, as shown in FIG. 1. In some embodiments, the remote computer system might be maintained by a service provider at a location that is remote from and in network communication with the user (i.e., with the user device associated with the user). The user device associated with the user can be any type of personal electronic device or computer, including, but not limited to, the user devices 105 and 205, as shown in FIGS. 1 and 2, respectively. The workflow management schedule might, in some embodiments, comprise one or more tasks and one or more dates for the initiation or completion of the one or more tasks.

The remote computer system, at block 310, might access reference schedules from a first set of databases, and compare, at block 315, tasks and dates in the workflow management schedule with reference tasks and reference dates in the reference schedules. The first set of databases or first databases might include, without limitation, schedule databases 125a and 125b, as shown in FIG. 1, or local database 230 and remote database 240, as shown in FIG. 2. At block 320, the process 300 might comprise identifying, with the remote computer system, at least one necessary task and/or at least one necessary date that are not included on the workflow management schedule, both from the reference schedules.

The process 300, at block 325, might access, using the remote computer system from a second set of databases, reference scopes of work associated with the at least one necessary task not included on the workflow management schedule. The second set of databases or second databases might include, without limitation, scope of work databases 135a, 135b, and 135c, as shown in FIG. 1, or local database 255 and remote database 265, as shown in FIG. 2. The reference scopes of work might, according to some embodiments, comprise such information as a listing of the subtasks for the at least one necessary task, a listing of personnel suggested for completion of the at least one necessary task, a listing of materials, equipment, and/or services suggested for completion of the at least one necessary task, a duration suggested for completion of the at least one necessary task, and the like. The remote computer system might then define a scope of work for each of the at least one necessary task not included on the workflow management schedule, based on the corresponding reference scopes of work (block 330). As part of defining the scope of work, some embodiments might include calculating at least one necessary date that is associated with each of the at least one necessary task, based at least in part on the duration of the reference tasks, and perhaps also based in part on other factors, such as contractual, financial, permit, or other restrictions, and the like. The at least one necessary date might include, but is not limited to, an estimated/desired commencement or start date, an estimated/desired completion date, one or more checkpoint or milestone dates in between, one or more deadlines for securing permits or other authorization, or the like.

At block 335, the process 300 might comprise adding the at least one necessary task, the corresponding at least one necessary date, and the corresponding defined scope of work to the workflow management schedule. The process 300 might further comprise sending a list of materials, equipment, and/or services suggested for completion of the at least one necessary task to appropriate suppliers and/or service providers (block 340). The appropriate suppliers, service providers, or both might include suppliers/service providers 140 and 285, as shown in FIGS. 1 and 2, respectively. The remote computer system, at block 345, might receive notification, from one or more appropriate suppliers, that necessary materials, equipment, or both have been provided in the field to the user and any additional personnel suggested for completion of the at least one necessary task. At block 350, the process 300 might include ordering any services suggested for completion of the at least one necessary task; the services might include, without limitation, third party survey work, transportation services, translation work, guide services, and aerial or satellite data acquisition, or the like. At block 355, the remote computer system might receive notification that the ordered service has commenced or has been completed.

The process 300 might comprise updating the user's workflow management schedule, at block 360, and updating the workflow management schedules of any additional personnel suggested for completion of the at least one necessary task (block 365) with the at least one necessary task, the at least one necessary date, and the at least one defined scope of work.

The process 300 might then wait for updates from the user and/or the additional personnel, if any. At block 370, the process 300 might comprise receiving, with the remote computer system, an indication from either the user or any of the additional personnel that at least a portion of the tasks—including the at least one necessary task, other tasks on the workflow management schedule, or both—has been completed. Subsequently, the process 300 might further comprise indicating in, and updating, the workflow management schedule of each of the user and any additional personnel that at least a portion of the tasks has been completed (block 375).

FIG. 3B is similar to FIG. 3A, except that rather than the process of comparing, identifying, and adding the at least one necessary task and at least one necessary date, in FIG. 3A, the process 300 in FIG. 3B might comprise comparing, identifying, and adding at least one workflow item—which, as discussed above, might include, without limitation, one or more of a task, a meeting, a project, a deadline, a time, a date, one or more work locations, or required data. Accordingly, at least blocks 315′, 320′, 335′ 340′, and 360′ through 375′ might reflect modification of blocks 315, 320, 335, 340, and 360 through 375, respectively, to expand at least one necessary task and at least one date to include at least one workflow item, as discussed above. Otherwise, the various steps in FIG. 3B are similar, if not identical to those in FIG. 3A, as described above.

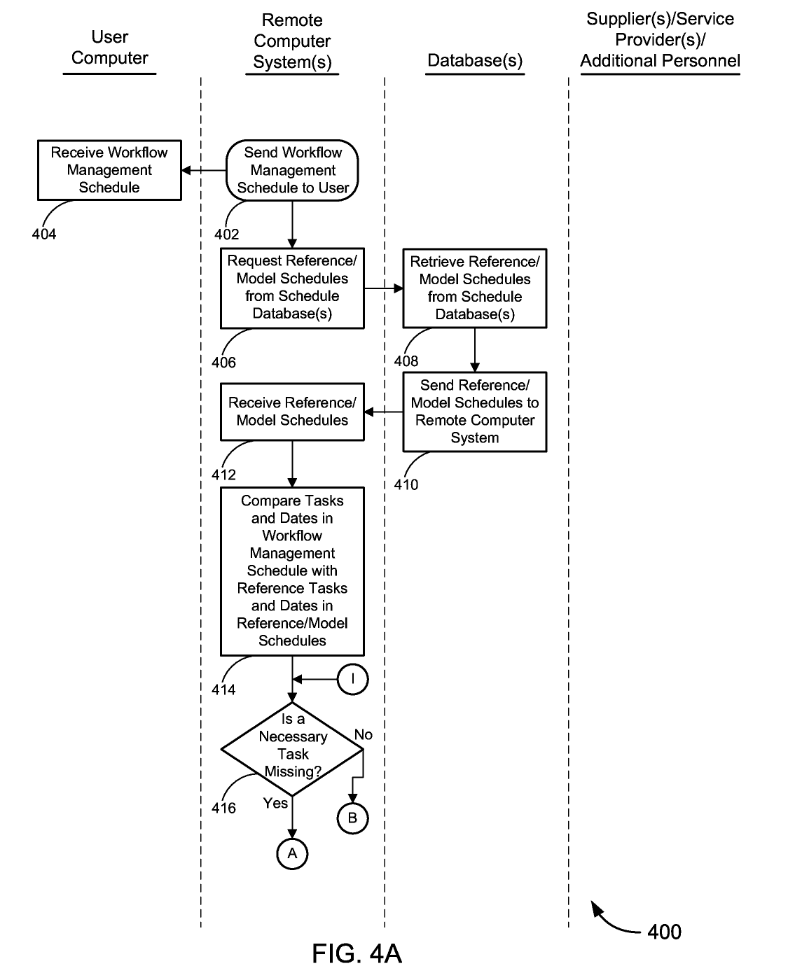

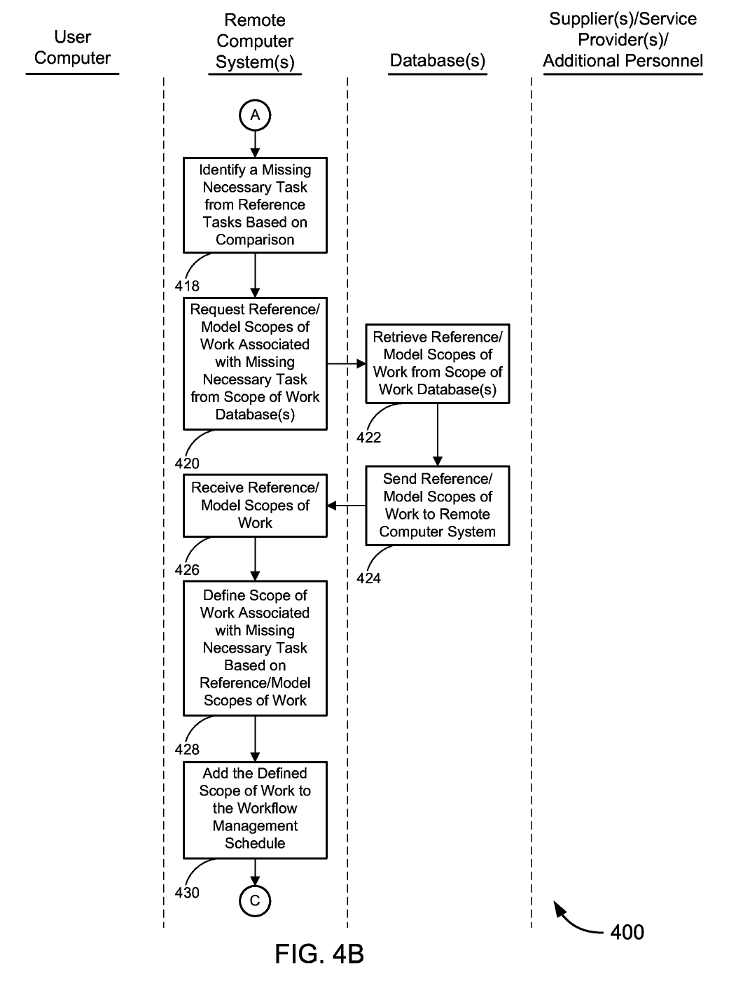

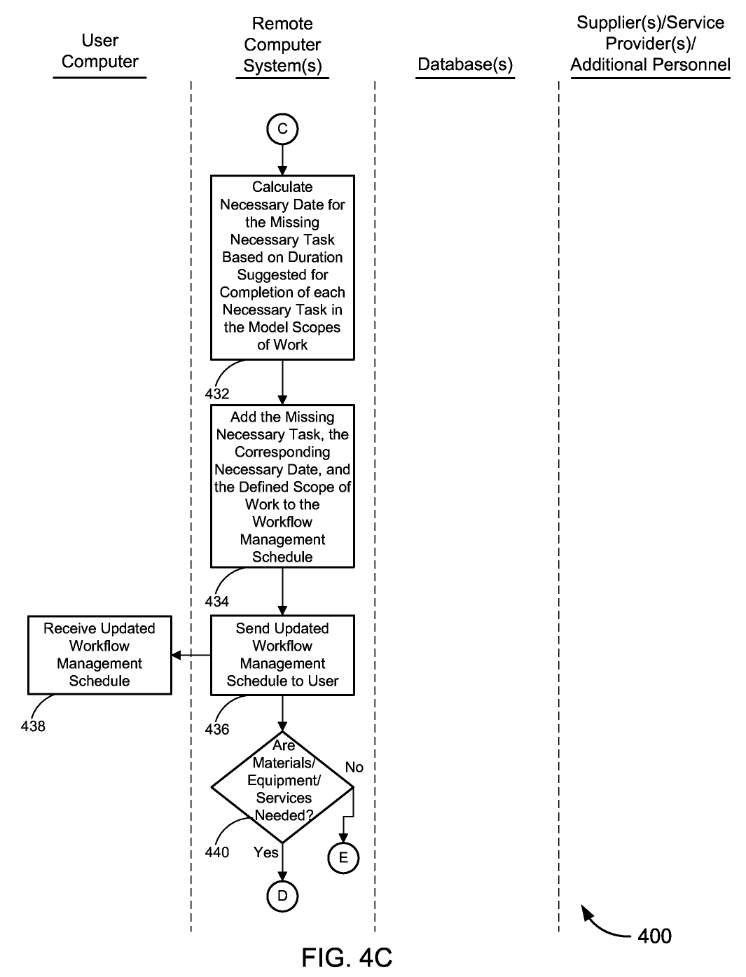

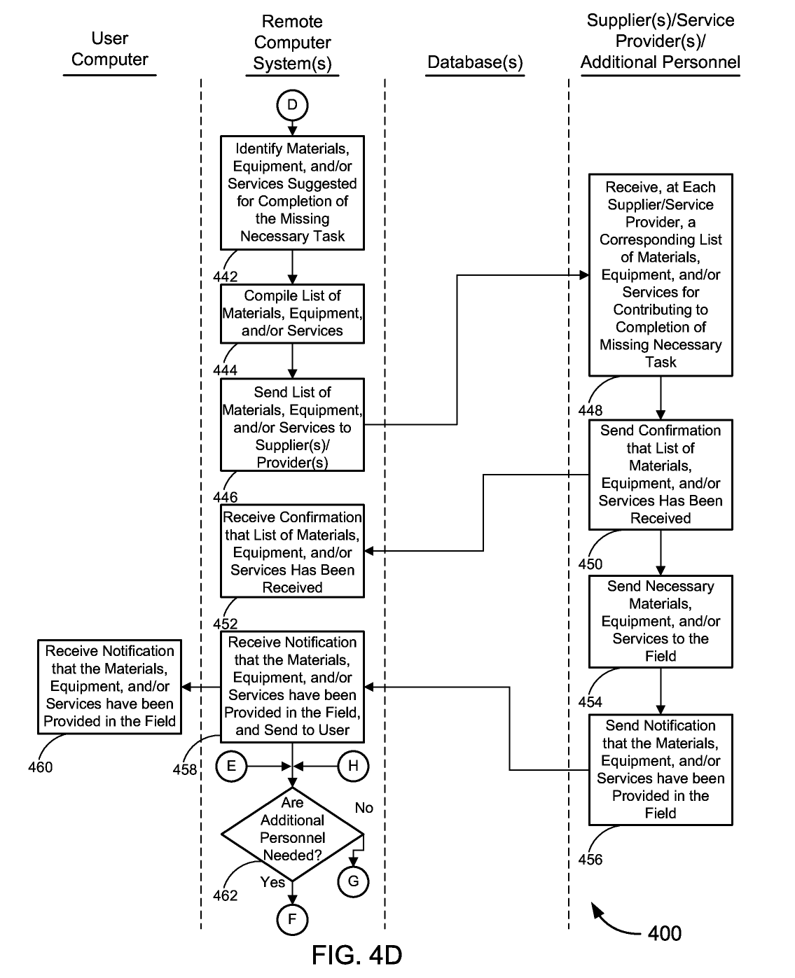

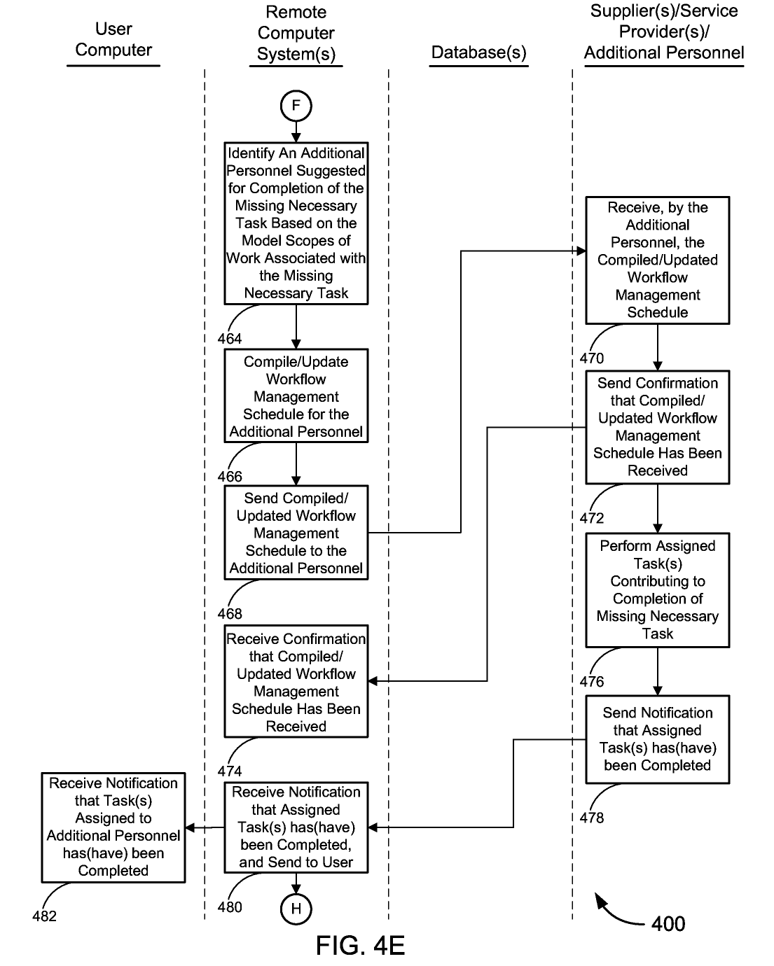

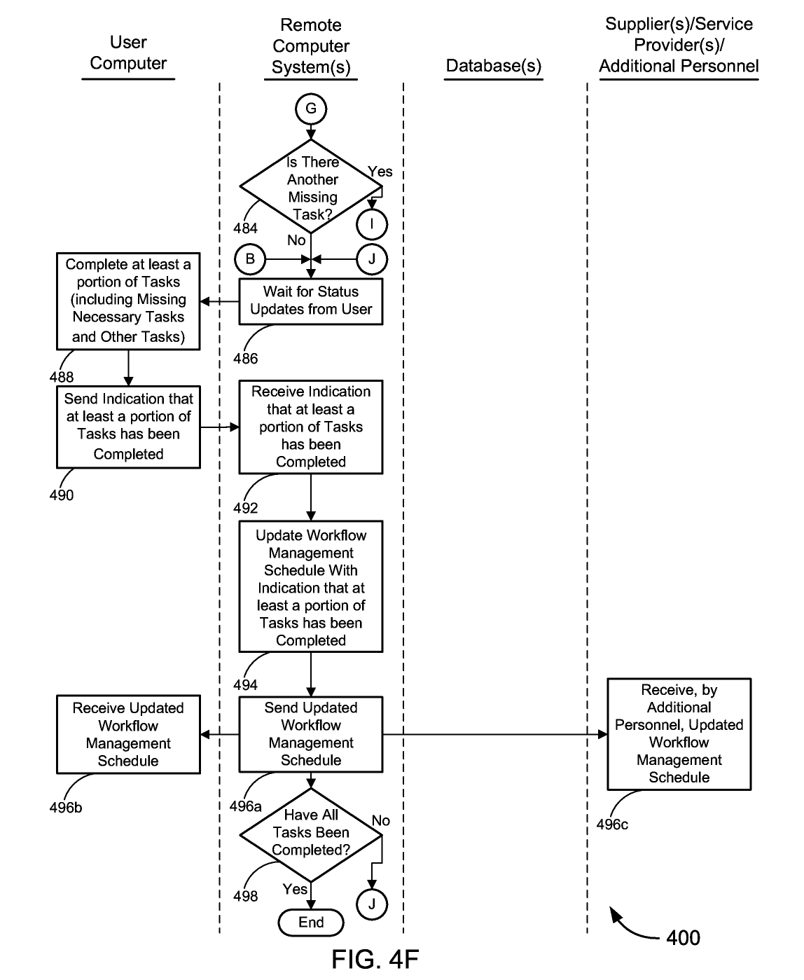

FIGS. 4A-4F (collectively, “FIG. 4”) represent a system flow diagram illustrating exemplary processes 400 performed at or by components of a system in order to manage workflow. The process in FIG. 4A continues onto FIG. 4B, linked by the circular marker denoted by “A.” Similarly, the process in FIG. 4B continues onto FIG. 4C, linked by the circular marker denoted by “C,” and the process in FIG. 4C continues onto FIG. 4D, linked by the circular marker denoted by “D” or “E.” The process in FIG. 4D continues onto FIG. 4E, linked by the circular marker denoted by “F,” and subsequently returns to FIG. 4D, linked by the circular marker denoted by “H,” while the process in FIG. 4D continues onto FIG. 4F, linked by the circular marker denoted by “G.” Circular markers denoted by “B” and “E” link to later blocks, while circular markers denoted by “H,” “I,” and “J” link to earlier blocks, in the process 400.

In FIG. 4A, the process 400 may begin at block 402 with the sending of a workflow management schedule from a remote computer system to a user at a user computer. The remote computer system might include, without limitation, remote computer system 100, as shown in FIG. 1. The user computer might include, but is not limited to, user computers or user devices 105a-105e, as shown in FIG. 1, or user devices 205a-205e, as shown in FIG. 2. The process 400 might concurrently, or sequentially (in either order), comprise receiving, at the user computer, the sent workflow management schedule (block 404), and requesting reference or model schedules from schedule databases (block 406). The schedule databases might comprise, without limitation, databases 125 in FIG. 1 or databases 230 and 240 in FIG. 2. The reference schedules might be retrieved, at block 408, from the schedule databases, and sent, at block 410, to the remote computer system. At block 412, the remote computer system might receive the reference schedules, and might transfer the reference schedules to a workflow management application, similar to that as described above with respect to FIG. 1. The workflow management application, which might be executed by a processor at the remote computer system, might, at block 414, compare tasks and dates in the workflow management schedule with reference tasks and dates in the reference schedules.

At block 416, a determination may be made, by the workflow management application running on the remote computer, as to whether a necessary task is not included in the workflow management schedule, based on the comparison in block 414. If so, the process 400 continues to block 418, as shown in FIG. 4B. If not, the process 400 proceeds to block 486, as shown in FIG. 4F.

Continuing onto FIG. 4B, the workflow management application might, at block 418, identify a missing necessary task from among other missing necessary tasks, as indicated in the reference tasks of the reference schedules, based on the comparison in block 414, and might request reference or model scopes of work associated with the subject missing necessary task (block 420). At block 422, the reference scopes of work might be retrieved from one or more scope of work databases, and sent, at block 424, to the remote computer system. The one or more scope of work databases might include, but is not limited to, databases 135 in FIG. 1 or databases 255 and 265 in FIG. 2. The remote computer system might receive the reference scopes of work associated with the missing necessary task, at block 426.

According to some embodiments, the workflow management application might, at block 428, define a scope of work associated with the missing necessary task, based on the reference scopes of work. Alternatively, the scope of work may be defined by a separate scope of work calculation program or software application, which may be running on the remote computer system or running on a supplemental computer system. The supplemental computer system might include, without limitation, supplemental computer system 130, as shown in FIG. 1, which may be remote from computer system 110, yet connected with the remote computer system 110 via network 115b. In such cases, the workflow management application might provide data associated with the workflow management schedule to the separate scope of work calculation program to enable the separate scope of work calculation program to define the scope of work associated with the missing necessary task. At block 430, the defined scope of work may be added to the workflow management schedule.

Continuing onto FIG. 4C, at block 432, the workflow management application, or the separate scope of work calculation program, might calculate the one or more necessary dates corresponding to the missing necessary task, based at least in part on a suggested duration for completion of the particular necessary task as indicated in the model scopes of work, and maybe also based in part on other factors. The one or more necessary dates might include, but is not limited to, a commencement or start date, a completion date, one or more milestone or checkpoint dates in between, one or more deadline dates for securing permits or other authorization, or the like. The other factors on which the calculation may also be partially based might include, without limitation, contractual, financial, permit, or other restrictions, and the like. The workflow management application might then add the missing necessary task, the corresponding one or more necessary dates, and the corresponding defined scope of work to the workflow management schedule (block 434), and send the updated workflow management schedule to the user (block 436), to be received at the user computer (block 438).

At block 440, a determination might be made as to whether any materials, equipment, and/or services might be needed. If so, process 400 continues to block 442, as shown in FIG. 4D. Otherwise, process 400 skips to block 462, as shown in FIG. 4D.

Continuing onto FIG. 4D, the workflow management application might identify, based on the model scopes of work associated with the missing necessary task, any materials, equipment, and/or services suggested for the completion of the missing necessary task (block 442). The suggested necessary materials, equipment, and/or services might be provided by one or more suppliers/service providers, who might be either suggested by the model scopes of work or selected by the workflow management application from a separate list of suppliers, a separate list of service providers, or a separate combined list of suppliers and service providers. For each chosen supplier or service provider, the workflow management application might, at block 444, compile a list of materials, equipment, and/or services that might be provided by the supplier or service provider, and might, at block 446, send said list to the supplier or service provider. The supplier or service provider might receive the list of materials, equipment, and/or services (at block 448), and might send a confirmation of receipt of the same (at block 450), the receipt of the confirmation being received at the remote computer system at block 452. At block 454, the supplier or service provider might send or otherwise provide the materials, equipment, and/or services indicated in said list to a location, to a user, to additional personnel, or the like in the field for completing the missing necessary task. A notification that the necessary materials, equipment, and/or services have been provided in the field might be sent to the remote computer, at block 456. At block 458, the remote computer might receive, and send to the user, the notification that the materials, equipment, and/or services have been provided in the field, with the notification being received by the user at the user computer at block 460. The process 400 might subsequently proceed to block 462.

At block 462, a determination might be made as to whether any additional personnel might be needed or suggested for the completion of the missing necessary task. If so, process 400 continues to block 464, as shown in FIG. 4E. Otherwise, process 400 skips to block 484, as shown in FIG. 4F.

Continuing onto FIG. 4E, the workflow management application might identify, based on the model scopes of work associated with the missing necessary task, an additional personnel, among a number of potential additional personnel, suggested for the completion of the missing necessary task (block 464). For the additional personnel, the workflow management application might, at block 466, compile or update a workflow management schedule tailored to the additional personnel, and might, at block 468, send the compiled or updated workflow management schedule to the additional personnel. In some embodiments, compiling or updating the workflow management schedule of the additional personnel may be accomplished by adding the missing necessary task to the task list of the additional personnel. The additional personnel might receive the compiled or updated workflow management schedule (at block 470), and might send a confirmation of receipt of the same (at block 472), the receipt of the confirmation being received at the remote computer system at block 474. At block 476, the additional personnel might perform one or more assigned tasks contributing to, or suggested for, the completion of the missing necessary task, and might send notification of completion of the one or more assigned tasks to the remote computer (block 478). At block 480, the remote computer might receive, and subsequently send to the user, the notification of completion of the one or more assigned tasks, with the notification being received by the user at the user computer at block 482. The process 400 might subsequently return to block 462 to determine whether any additional personnel might be needed to complete the (same) missing necessary task. If so, the process at blocks 464 through 482 might be repeated. Otherwise, the process 400 continues to block 484, as shown in FIG. 4F.

Continuing onto FIG. 4F, a determination might be made, at block 484, as to whether another (i.e., different) necessary task might be missing. If so, the process returns to block 416. If not, the process 400 continues to block 486

At block 486, the remote computer system might wait for status updates from the user. The user, at block 488, might complete at least a portion of the tasks, including at least a portion of the one or more missing necessary tasks, or at least a portion of one or more of the other tasks in the workflow management schedule. The user might subsequently send an indication to the remote computer system that at least a portion of the tasks has been completed (block 490), with the remote computer receiving said indication at block 492. At block 494, the workflow management application running on the remote computer system might update the user's workflow management schedule to include an indication that at least a portion of the tasks has been completed, and might send the updates at block 496. Block 496 might comprise blocks 496a-496c. At block 496a, the updated workflow management schedule, or an updated portion thereof, might be sent to the user and any additional personnel. As discussed above, either a portion or the entire workflow management schedule residing at the user devices associated with the user and any additional personnel might be replaced with the updated information. In this case, the updated information might include information regarding whether one or more tasks listed in the workflow management schedule has been completed. At blocks 496b and 496c, the updated workflow management schedule, or the updated portions thereof, may be received at the user computer associated with the user and at the user device associated with the additional personnel, respectively.

A determination may subsequently be made as to whether all tasks in the workflow management schedule, including the missing necessary tasks as well as the other tasks, have been completed (block 498). If not, the process 400 returns to block 486. If so, the process 400 terminates.

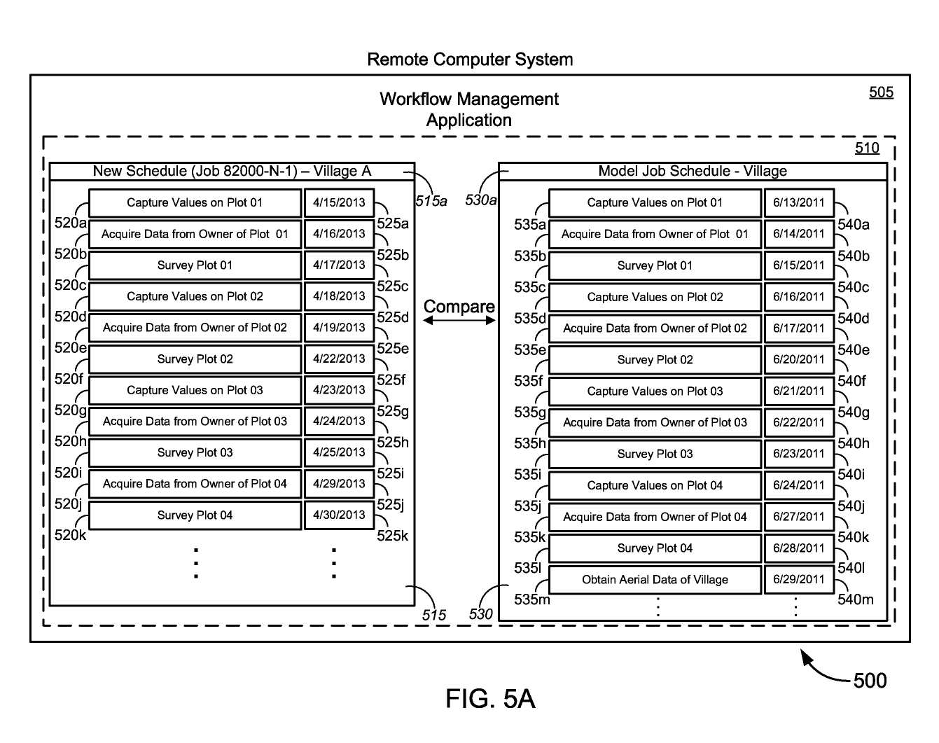

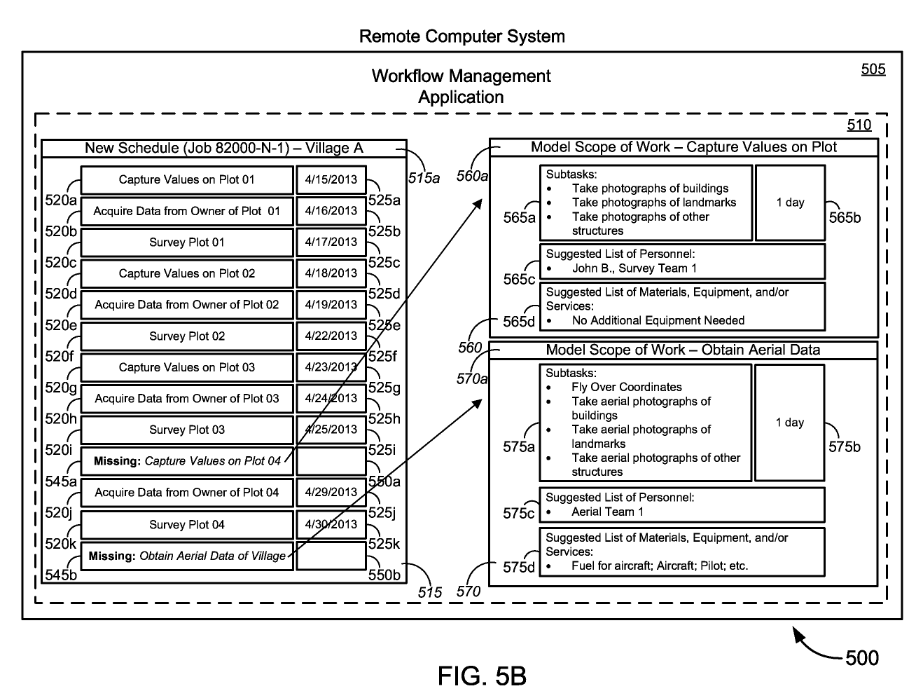

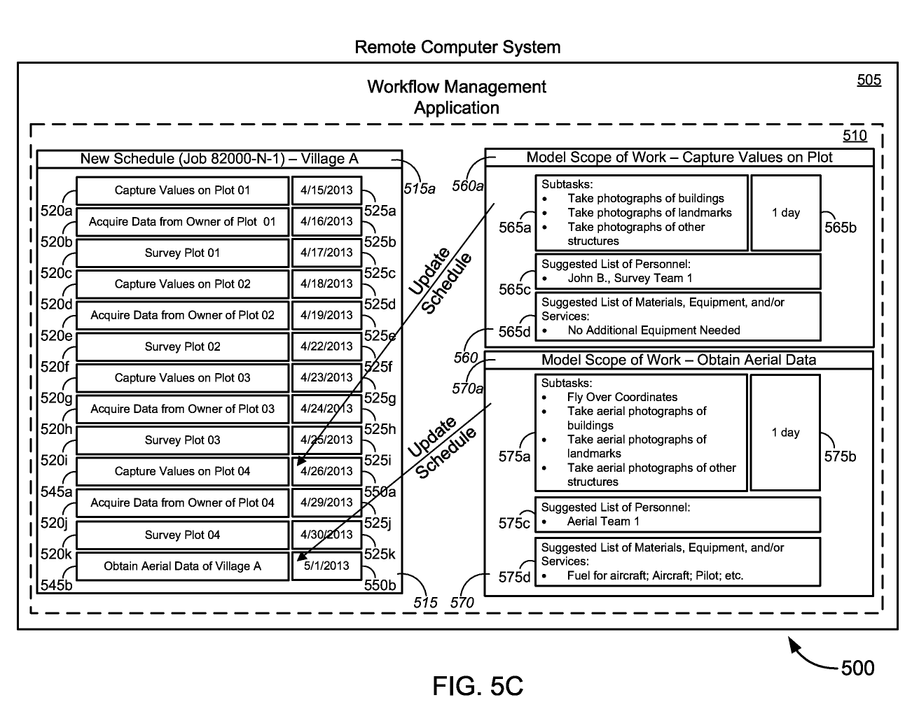

FIGS. 5A-5C (collectively, “FIG. 5”) represent an exemplary process 500 of workflow management as performed by a workflow management application that is executed by a processor at a remote computer system. In particular, FIG. 5 illustrates, from the perspective of the workflow management application running on the remote computer system, an example of a process of identifying missing necessary tasks and dates, calculating one or more missing dates corresponding to each missing necessary task, and updating the user's workflow management schedule with the missing necessary tasks, and one or more corresponding dates. Process 500 of FIG. 5 may be used in conjunction with, or alternative to corresponding processes of, any of the embodiments as described herein with respect to FIGS. 1-4 and 6-8.

In FIG. 5A, remote computer system 505 might comprise a processor that may be used to execute workflow management application 510. Workflow management application 510, when executed by the processor, causes the processor to compare a workflow management schedule 515 that has been sent to a user with reference or model schedules 530. As shown in FIG. 5A, a new schedule 515 might comprise a header 515a, a plurality of task fields 520, a plurality of date fields 525, and the like. Header 515a might be a data file header or other suitable header or tag. In this example, header 515a might indicate “New Schedule (Job 82000-N-1)—Village A” for a cadastral survey project of Village A. The plurality of task fields 520 might comprise a plurality of task subfields 520a-520k indicating what tasks are necessary for completing the cadastral survey of Village A, for example. The plurality of date fields 525 might comprise a plurality of date subfields 525a-525k, each corresponding to one of the task subfields 520a-520k. The plurality of date fields 525 might indicate one or more of a commencement or start date, a completion date, one or more milestone dates, one or more deadlines for securing permits or other authorization, and the like. In some embodiments, each subfield 520a-520k might be divided into multiple subfields each indicating one of the commencement or start date, the completion date, the one or more milestone dates, the one or more deadlines for securing permits or other authorization, and the like. In other embodiments, each subfield 520a-520k might indicate any applicable ones of the commencement or start date, the completion date, the one or more milestone dates, the one or more deadlines for securing permits or other authorization, and the like.

Reference or model schedules 530 might be based on prior projects, based on modeled schedules, based on user compiled information, or a combination of these pieces of information, and might comprise a plurality of model schedules each comprising a header 530a, a plurality of reference task fields 535, a plurality of reference date fields 540, and the like. Header 530a, like header 515a, might be a data file header or other suitable header or tag. Header 530a might, for example, indicate “Model Job Schedule—Village.” The plurality of reference task fields 535 might comprise a plurality of reference task subfields 535a-535m indicating necessary tasks for completing a cadastral survey of a model village. The plurality of reference date fields 540 might comprise a plurality of reference data subfields 540a-540m, each of which might correspond to one of the reference task subfields 535a-535m. Similar to the date fields 525 in workflow management schedule 515, the reference date fields 540 might indicate one or more of a model commencement or start date, a model completion date, one or more model milestone dates, one or more model deadlines for securing permits or other authorization, and the like. In some embodiments, each subfield 520a-520k might be divided into multiple subfields each indicating one of the model commencement or start date, the model completion date, the one or more model milestone dates, the one or more model deadlines for securing permits or other authorization, and the like. In other embodiments, each subfield 520a-520k might indicate any applicable ones of the model commencement or start date, the model completion date, the one or more model milestone dates, the one or more model deadline dates for securing permits or other authorization, and the like.

In FIG. 5B, workflow management application 510 might identify missing necessary tasks, based on the comparison, and might add the missing tasks into newly created necessary task subfields 545. For example, based on the comparison in FIG. 5A, a plurality of necessary task subfields 545 might include subfields 545a and 545b, indicating “Capture Values on Plot 04” and “Obtain Aerial Data of Village,” respectively. In some embodiments, additional indications, such as “missing,” “new,” “necessary,” and the like, or any combination of such indications, may be included in each of the plurality of necessary task subfields 545. Necessary date subfields 550, including subfields 550a and 550b, corresponding to necessary task subfields 545a and 545b, respectively, may also be created. To fill necessary date subfields 550, workflow management application 510 might calculate for each missing necessary task the corresponding necessary date or dates based at least in part on a duration suggested for completion of the subject necessary task as indicated in one or more model scopes of work 560 or 570.

For example, for the necessary task of capturing values on a plot, workflow management application 510 might access one or more model scopes of work 560 associated with capturing values on a plot. Such a model scope of work 560 might include a header 560a and content fields 565. Header 560a might be similar to headers 515a and 530a described above, and might indicate “Model Scope of Work—Capture Values on Plot,” for example. The content fields 565 might include, without limitation, one or more subtask fields 565a, one or more duration fields 565b, one or more fields containing lists of suggested personnel 565c, one or more fields containing lists of suggested materials, equipment, and/or services 565d, and the like, or any combination of such fields. The one or more subtask fields 565a might define subtasks for capturing values on a plot. For example, the defined subtasks might include obtaining photographic images or video images of buildings, landmarks, or other structures on the plot of land, or the like. The one or more duration fields 565b might include a suggested time for completion of the subtasks, either individually or as a whole, or might include suggested durations for reaching certain milestones or checkpoints in the necessary task (in this case, capturing values on a plot). The one or more fields containing lists of suggested personnel 565c might identify persons or teams of persons, or both, (such as “John B., Survey Team 1”) for completion of the necessary task. The one or more fields containing lists of suggested materials, equipment, and/or services 565d might indicate what is required for completion of the task or might indicate that no additional equipment is needed, or the like.

In another example, for the necessary task of obtaining aerial data, workflow management application 510 might access one or more model scopes of work 570 associated with obtaining aerial data. Such a model scope of work 570 might include a header 570a and content fields 575. Header 570a might be similar to headers 515a, 530a, and 560a described above, and might indicate “Model Scope of Work—Obtain Aerial Data,” for example. The content fields 575 might include, without limitation, one or more subtask fields 575a, one or more duration fields 575b, one or more fields containing lists of suggested personnel 575c, one or more fields containing lists of suggested materials, equipment, and/or services 575d, and the like, or any combination of such fields. The one or more subtask fields 575a might define subtasks for obtaining aerial data. For example, the defined subtasks might include flying over some preset geographic coordinates and obtaining aerial photographic images or video images of buildings, landmarks, or other structures on the plot of land, or the like. The one or more duration fields 575b might include a suggested time for completion of the subtasks, either individually or as a whole, or might include suggested durations for reaching certain milestones or checkpoints in the necessary task (in this case, obtaining aerial data). The one or more fields containing lists of suggested personnel 575c might identify persons or teams of persons, or both, (such as “Aerial Team 1”) for completion of the necessary task. The one or more fields containing lists of suggested materials, equipment, and/or services 575d might indicate what is required for completion of the task or might indicate that no additional equipment is needed, or the like. In this example, the list of suggested materials, equipment, and/or services might include, but is not limited to, obtaining fuel for aircraft, chartering an aircraft, hiring a pilot, or the like.

In FIG. 5C, the workflow management application 510 might update the workflow management schedule 515 with the missing necessary tasks by creating and/or filling subfields 545, if not previously created or filled. The workflow management application 510 might also update the workflow management schedule 515 with the corresponding one or more dates by creating and/or filling subfields 550, if not previously created or filled. For example, subfields 545a and 550a might indicate “Capture Values on Plot 04” and “Apr. 26, 2013,” respectively. The date “Apr. 26, 2013” might be a start date, a completion date, a milestone date, or a permit or authorization deadline date, or the like associated with the task of capturing values on plot 04. Likewise, subfields 545b and 550b might indicate “Obtain Aerial Data of Village A” and “May 1, 2013,” respectively. The date “May 1, 2013” might be a start date, a completion date, a milestone date, or a permit or authorization deadline date, or the like associated with the task of obtaining aerial data of village A.

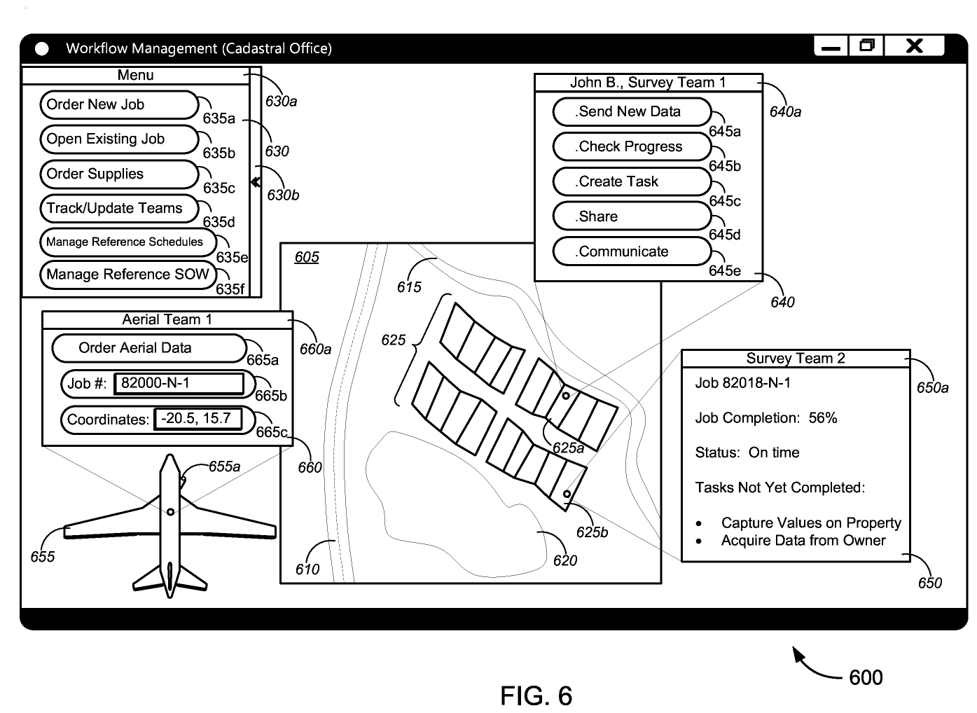

FIG. 6 is an exemplary graphical user interface 600 for workflow management that is presented to a user. In FIG. 6, a graphical user interface (“GUI”) 600 might be designed for use by, for example, a cadastral worker based at a regional or national cadastral office. GUI 600 might display a map 605 of the region of interest, which might include a road or other vehicular path 610, a river, stream, or other waterway 615, a lake or other body of water 620, and the plurality of plots of land 625, which might include plot 625a and 625b. GUI 600 might further display a menu panel 630, which might include, without limitation, header 630a, reveal/hide button 630b, and a plurality of buttons or links 635. Header 630a might be any type of title or header for a graphical user interface window or for a tab in the graphical user interface window. For example, Header 630a might indicate “Menu” for the menu panel 630. In some embodiments, the menu panel 630 may be hidden when not in use, with only the reveal/hide button 630b visible within GUI 600. By clicking on the reveal/hide button 630b, the menu panel 630 may be revealed. To hide the menu panel 630, the user might click the reveal/hide button 630b a second time. The plurality of buttons or links 635 might include, without limitation, buttons or links 635a-635f, which might initiate series of instructions for performing one or more of ordering a new job 635a, opening existing jobs 635b, ordering supplies for particular jobs 635c, tracking or updating teams with information and/or workflow management schedules 635d, manage reference or model schedules 635e, manage reference or model scopes of work (“SOW”), and the like. Managing the reference schedules and the reference scopes of work is described in detail below.

GUI 600 might further comprise one or more information panels 640, 650, and 660 associated with the various field teams, and the like. For example, information panel 640 might be associated with survey team 1 on plot 625a. Information panel 640 might comprise header 640a and buttons or links 645. Header 640a might be similar to header 630a. Buttons or links 645 might include, without limitation, buttons or links 645a-645e, which might initiate series of instructions for performing one or more of sending new data to the team 645a, checking the progress of the team 645b, creating a new task to be completed by the team 645c, sharing information with the team 645d, otherwise communicating with the team or members of the team 645e, and the like. In some embodiments, the information panel 640 might comprise one or more information panels 640 of members of the team—for example, John B. on survey team 1. This is particularly applicable where each member might have tasks different from other members of the team or might be sent to locations different from the other members of the team.

In another example, information panel 650 might be associated with survey team 2 on plot 625b. Information panel 650 might include header 650a, which might be similar to headers 630a and 640a. Information panel 650 might comprise status updates of the team and/or information related to the current task on plot 625b, including, but not limited to, the job number, percent of the task completed, status of the task, tasks or subtasks yet to be completed, and the like. Information panel 650 might comprise one or more panels 650—a panel for the team, a panel for each of the members on the team, or both.

In some embodiments, aerial data may be required, in which case, an icon of an aircraft 655 having camera or other data acquisition equipment 655a might be displayed in GUI 600 to indicate that aerial data has been ordered or should be ordered. In some embodiments, aerial data may be ordered as a new job to be handled by cadastral workers or as services by third party service providers, which might depend upon whether the cadastral office owns, or is otherwise affiliated with persons or companies that own, aircraft 655. According to some embodiments, ordering of the aerial data may be performed automatically by a workflow management application running on a remote computer system—for example, according to blocks 440 through 458 of the embodiment of FIG. 4, or the like. In alternative embodiments, ordering of the aerial data may be performed by the user at the regional or national cadastral office using GUI 600.

Information panel 660, which might be associated with obtaining aerial data, might include header 660a and buttons or links 665. Header 660a might be similar to headers 630a, 640a, and 650a. Buttons or links 665 might include buttons for initiating series of instructions for ordering aerial data 665a, which might include ordering aerial photographic images or video images, and the like. Buttons or links 665 might further include fields 665b and 665c for allowing the user to enter a job number and to enter geographic coordinates for the site at which the aerial data is required, respectively. Geographic coordinates might include global positioning system (“GPS”) coordinates and/or other suitable latitude and longitude information of any appropriate geographic coordinate system, and can be in any suitable format, including in decimal degree format and degrees/minutes/seconds format. For example, the coordinates “−20.5, 15.7” in field 665c might refer to 20.5 degrees south of the Equator and 15.7 degrees east of the Prime Meridian, or 20 degrees south, 30 minutes, and 0 seconds by 15 degrees east, 42 minutes, and 0 seconds, or 20° 30′ 0″ S, 15° 42′ 0″ E, which refers to a location in Namibia.

According to some embodiments, GUI 600 might include calendar or flow diagram views of the pending projects, or of tasks of each pending project, or both, with the corresponding one or more dates as discussed above.

In some embodiments, GUI 600 may simply present the user at the regional or national cadastral office with progress information related to the workflow management method and system as described above with respect to FIGS. 1-5. For example, GUI 600 might display indications of which steps of the processes 200, 300, 400, and 500 might have been completed, whether necessary tasks and dates are missing from workflow management schedules sent to cadastral field workers, which necessary task are missing, the defined scopes of work for the missing necessary tasks, and the like.

GUI 600 might also provide the user at the cadastral office with options to add, delete, or edit workflow items in the workflow management schedules sent to the field users, or to otherwise manage the workflow management schedules. Likewise, GUI 600 might provide the user at the cadastral office with options to add, delete, or edit defined scopes of work sent to the field users, or to otherwise manage the defined scopes of work. In some embodiments, options to manage the workflow management schedules, the defined scopes of work, or both may be provided in response to the user pressing or clicking on button or link 635d (i.e., “Track/Update Teams”).

General updates to the reference or model schedules, to the reference or model scopes of work, or both may also be managed via GUI 600. Options to manage the reference or model schedules may be provided in response to the user pressing or clicking on button or link 635e (i.e., “Manage Reference Schedules”), while options to manage the reference or model scopes of work may be provided in response to the user pressing or clicking on button or link 635f (i.e., “Manage Reference SOF”).

The general updates to the reference or model schedules might include, without limitation, additional tasks to be added in light of new procedures, new policies, new governmental regulations, or the like, or any combination of these occurrences. For the reference or model scopes of work, general updates might include, but are not limited to, an updated list of additional personnel, an updated list of suppliers or service providers, an updated duration suggested for completion of necessary tasks, an updated list of sub-tasks associated with necessary tasks, and the like. The updated list of additional personnel might be based on information regarding new employees, retired employees, or employees who have otherwise left the agency or department. The updated list of suppliers or service providers might be based on contractual changes with third party suppliers, third party service providers, or both. The updated duration suggested for completion of necessary tasks, the updated list of sub-tasks associated with necessary tasks, or both might be based on new procedures, new policies, new governmental regulations, or the like.

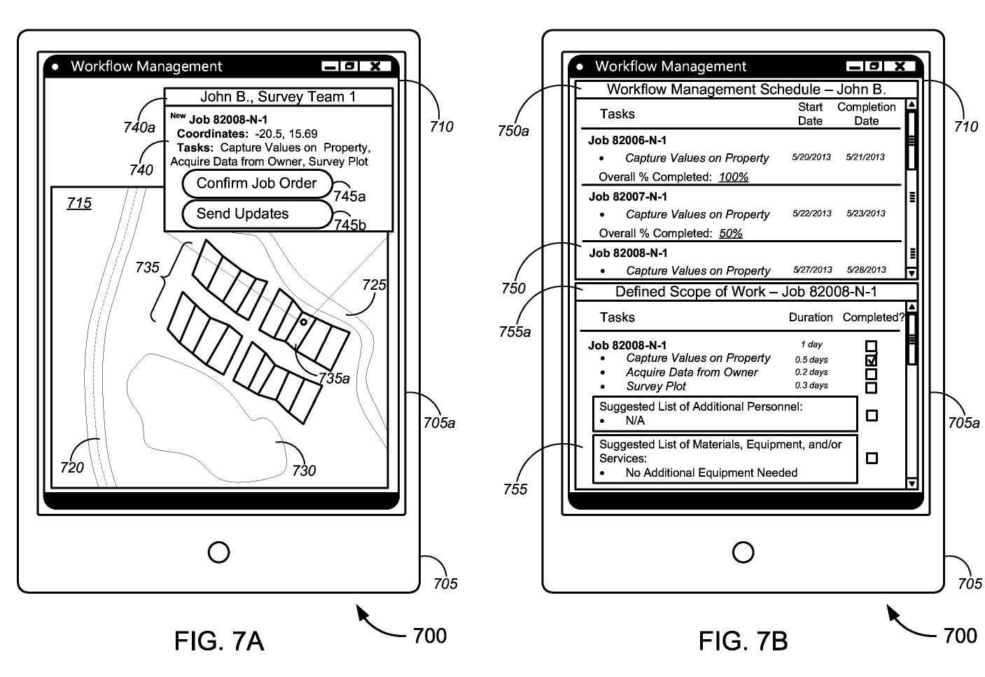

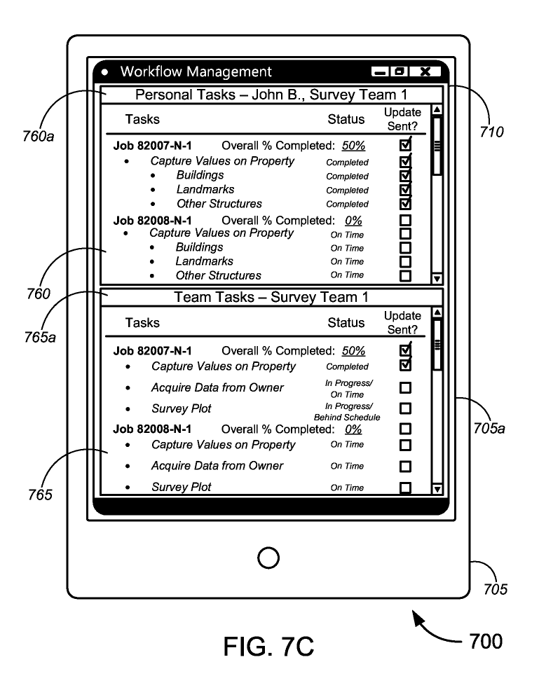

FIGS. 7A-7C (collectively, “FIG. 7”) are exemplary illustrations of mobile user devices 700 used by users that present graphical user interfaces that incorporate workflow management. For purposes of illustration only, user device 700 in FIG. 7 is shown as a tablet computer, but can be any user computer or user device including, but not limited to, a desktop or PC, a laptop computer, a tablet computer, a smart phone, a mobile phone, or the like—such as a desktop or PC 105a, a laptop computer 105b, a tablet computer 105c, a smart phone 105d, and a mobile phone 105e, as shown in FIG. 1. User device 700 might comprise device housing 705, display screen 705a, and the like. Display screen 705a might comprise a touchscreen display, a non-touchscreen display, or the like. Displayed on the display screen 705a might be a graphical user interface (“GUI”) 710, which may be a free floating GUI window filling a portion of the display screen 705a or may be a software application that fills the entire display screen 705a.

In FIG. 7A, the user device 700 might receive workflow management data ordering tasks or projects to be completed by a user associated with user device 700. In a cadastral survey example, the user might be a cadastral field worker and the workflow management might relate to cadastral survey projects and tasks to be handled by the cadastral field worker. When the user is provided instructions to perform a new project or task, the user might be sent a map 715 of the region, which might be displayed in display screen 705a. The map 715 might depict a roadway or vehicular path 720, a river, stream, or other waterway 725, a lake or other body of water 730, and the plurality of plots to be surveyed 735. The plurality of plots 735 might be plots within a village or within a portion of a village. The instructions might also comprise other information, including, but not limited to, one or more job numbers, one or more sets of geographic coordinates, one or more tasks or subtasks, or the like, that might be displayed in the GUI 710 in the form of an information panel 740 having a header 740a. Header 740a might be similar to headers 630a, 640a, 650a, and 660a as shown in, and described above with respect to, FIG. 6. In some embodiments, information panel 740 might include one or more buttons or links 745, which might comprise, without limitation, a button or link 745a to confirm receipt of the job order, a button or link 745b to send updates, or the like. The button or link 745b might be used to send updates to a remote computer system (as discussed with respect to FIGS. 1-5), to the regional or national cadastral office, or to both.

In FIG. 7B, the user—in this case, “John B.”—might be provided with a workflow management schedule 750 having header 750a, which is similar to header 740a. The workflow management schedule might include one or more tasks, such as Jobs 82006-N-1, 82007-N-1, 82008-N-1, and the like. For each job or task, a general description, such as “Capture Values on Property,” might be provided. Also provided might be an estimated or desired start date, an estimated or desired completion date, an indication of the percentage of completion of each job or task, or the like. Other information consistent with the information discussed with respect to the embodiments of FIGS. 1-6 may also be displayed in the workflow management schedule 750.

In addition to the workflow management schedule, the user might be provided with a defined scope of work for each job or task. For example, the defined scope of work 755 for new Job 82008-N-1 might include a list of subtasks, a suggested duration for each of the task and subtask, a suggested list of additional personnel, a suggested list of materials, equipment, and/or services, and the like. In some embodiments, the defined scope of work might provide the user with user input fields such as radial buttons or checkmark fields, or the like, to allow the user to send updates regarding completion of subtasks, tasks, or both. According to some embodiments, the workflow management schedule might be provided in a separate panel from the defined scope of work for each job or task. In other embodiments, the defined scope of work for each job or task may be incorporated within the workflow management schedule 750.

In FIG. 7C, the user might be provided with an information panel 760 that lists the personal tasks for the user. The information panel 760 might include header 760a, which might be similar to headers 740a and 750a. The information panel 760 might list the personal tasks of the user, together with subtasks, statuses of subtasks and tasks, overall percentage of the task completed, or the like. In some examples, the information panel 760 might provide the user with indications—e.g., in the form of check marked fields, or the like—to indicate whether updates have been sent for each subtask or task.

According to some embodiments, information panel 765 might be provided to list the team tasks for the team of which the user is a member. The information panel 765 might comprise header 765a, similar to headers 740a, 750a, and 760a. The same or similar information regarding the tasks displayed in information panel 760 might be displayed in information panel 765, except that information panel 765 might compile all the tasks and subtasks assigned to the entire team to which the user belongs.

With reference to information panels 760 and 765, the user (in this case, “John B.”) might be provided with subtasks that the user is assigned for contributing to the completion of the task in information panel 760, while the user might be provided with the tasks and subtasks assigned to the team as a whole (in this case, to “Survey Team 1”) in information panel 765. For example, John B. might be assigned the task of capturing values on the property, which might include taking photographic or video images of buildings, landmarks, or other structures on the property. Survey Team 1, as a whole, might be assigned the subtasks of capturing values on the property, acquiring data from the owner, and surveying the plot of land, the latter two subtasks being assigned to other members on Survey Team 1.

Using the workflow management software on the user devices 700, the user may be able to keep track of all the tasks and subtasks assigned to him or her, including any additional necessary tasks that the workflow management application at a remote computer might determine is missing from the workflow management schedule sent to the user, as described above with respect to the embodiments of FIGS. 1-5.

According to some embodiments, GUI 710 might include calendar or flow diagram views of the pending projects, or of tasks of each pending project, or both that may be assigned to the field user and/or to the field team, with the corresponding one or more dates as discussed above.

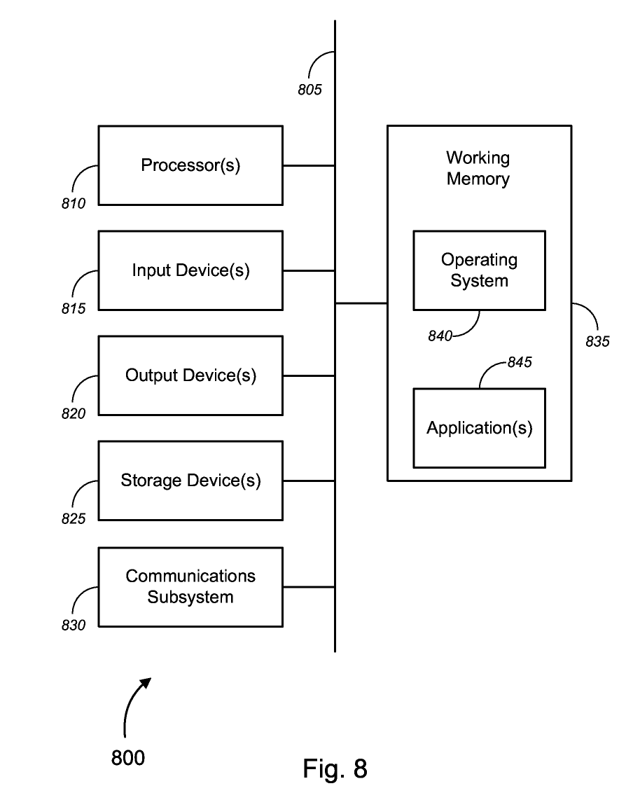

We now turn to FIG. 8, which is a block diagram illustrating an exemplary computer architecture. FIG. 8 provides a schematic illustration of one embodiment of a computer system 800 that can perform the methods provided by various other embodiments, as described herein, and/or can perform the functions of local computer system 105 or 205, or remote computer system 110 or 130, or other computer systems as described above. It should be noted that FIG. 8 is meant only to provide a generalized illustration of various components, of which one or more, or none, of each may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805, or may otherwise be in communication, as appropriate. The hardware elements may include one or more processors 810, including without limitation one or more general-purpose processors, or one or more special-purpose processors such as digital signal processing chips, graphics acceleration processors, or the like; one or more input devices 815, which can include without limitation a mouse, a keyboard, or the like; and one or more output devices 820, which can include without limitation a display device, a printer, or the like.

The computer system 800 may further include, or be in communication with, one or more storage devices 825. The one or more storage devices 825 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including without limitation various file systems, database structures, or the like.

The computer system 800 might also include a communications subsystem 830, which can include without limitation a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 830 may permit data to be exchanged with a network (such as network 115, to name an example), with other computer systems, with any other devices described herein, or with any combination of network, systems, and devices. According to some embodiments, network 115 might include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 800 will further comprise a working memory 835, which can include a RAM or ROM device, as described above.

The computer system 800 also may comprise software elements, shown as being currently located within the working memory 835, including an operating system 840, device drivers, executable libraries, or other code. The software elements may include one or more application programs 845, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 825 described above. In some cases, the storage medium might be incorporated within a computer system, such as the system 800. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 800, or might take the form of source or installable code. The source or installable code, upon compilation, installation, or both compilation and installation, on the computer system 800 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 800, to perform methods in accordance with various embodiments of the invention. According to a set of embodiments, some or all of the procedures of such methods might be performed by the computer system 800 in response to processor 810 executing one or more sequences of one or more instructions. The one or more instructions might be incorporated into the operating system 840 or other code that may be contained in the working memory 835, such as an application program 845. Such instructions may be read into the working memory 835 from another computer readable medium, such as one or more of the storage devices 825. Merely by way of example, execution of the sequences of instructions contained in the working memory 835 might cause the one or more processors 810 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 800, various computer readable media might be involved in providing instructions or code to the one or more processors 810 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and transmission media. Non-volatile media includes, for example, optical disks, magnetic disks, or both, such as the storage devices 825. Volatile media includes, without limitation, dynamic memory, such as the working memory 835. Transmission media includes, without limitation, coaxial cables, copper wire and fiber optics, including the wires that comprise the bus 805, as well as the various components of the communication subsystem 830, or the media by which the communications subsystem 830 provides communication with other devices. Hence, transmission media can also take the form of waves, including without limitation radio, acoustic, or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

Although the various embodiments are generally or specifically directed to cadastral surveys, the various embodiments are not so limited. The process of identification of objects and/or persons may be implemented in any setting and for any purpose. For example, land survey workers, geographic information system (“GIS”) workers, and the like might benefit from the workflow management method and system described above. Likewise, the workflow management method and system described above may be applicable to construction companies, oil and gas companies, utilities, service providers, and the like who may utilize the workflow management method and system to establish and maintain efficient and integrated operations. Product suppliers and service providers may also utilize the workflow management method and system to ensure an unbroken chain of supply and demand, and to ensure that necessary client/customer interactions are timely scheduled. Governmental agencies and departments may also benefit by the workflow management method and system above, which might allow for achieving efficient operations—for example, the postal service may utilize the workflow management system to ensure that every necessary step is taken for delivering each package. In some examples, search and rescue operations or other emergency operations could utilize the workflow management method and system to ensure that appropriate members of the teams are sent to appropriate locations to help victims of natural and/or occurrences and/or disasters (e.g., conflicts, earthquakes, hurricanes, tornadoes, volcanic eruptions, tsunamis, etc.) in real-time with continual updates, and the like. The updates might include up-to-date information on dangerous regions/areas as well as safe ones, for coordination with ground crews/personnel, up-to-date information on locations of missing persons, and the like. These are but a few examples of the functionalities made possible by the workflow management system and method as described above.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method comprising:
providing to a user, from a computer system maintained by a service provider at a location which is remote from and in network communication with the user, a workflow management schedule comprising one or more tasks and one or more dates for the initiation or completion of said tasks, wherein said one or more tasks are associated with the preparation of a cadastral survey;
comparing, with the remote computer system, the tasks and the dates included on the workflow management schedule with reference tasks and reference dates included on at least one of multiple reference schedules derived from prior cadastral survey projects and maintained by the service provider in a database including reference schedules;
identifying, with the remote computer system, from at least one reference schedule, at least one necessary task and at least one necessary date not included on the workflow management schedule;
defining, with the remote computer system, a scope of work associated with the necessary task, wherein said scope of work comprises a listing of subtasks suggested for completion of the necessary task, a listing of personnel suggested for completion of the necessary task, a listing of materials, equipment, and services suggested for completion of the necessary task, and a duration suggested for completion of the necessary task, wherein the scope of work is derived from scopes of work associated with prior cadastral survey projects and maintained by the service provider in a database including prior scopes of work;
adding, with the remote computer system, at least one necessary task, at least one necessary date, and at least one defined scope of work to the workflow management schedule;
communicating the added at least one necessary task, the added at least one necessary date, and the added at least one defined scope of work from the remote computer system to one or more schedules maintained by one or more personnel suggested for completion of the necessary task;
communicating the listing of materials, equipment, and services suggested for completion of the necessary task from the remote computer system to one or more of a supplier of cadastral materials and equipment or a provider of services;
receiving, at the remote computer system, an indication from the user that at least a portion of the necessary task is completed; and
indicating on the workflow management schedule, with the remote computer system, the completion of at least a portion of the necessary task.

2. A method, comprising:
providing, with a computer system, a workflow management schedule including one or more workflow items;
comparing, with the computer system, the one or more workflow items included on the workflow management schedule with workflow items included on a reference schedule;
identifying, with the computer system, a necessary workflow item included on the reference schedule not included on the workflow management schedule; and
adding, with the computer system, the necessary workflow item to the workflow management schedule.

3. The method of claim 2, wherein the one or more workflow items comprise one or more of a task, a meeting, a project, a deadline, a time, a date, one or more locations, or required data.

4. The method of claim 2, wherein at least one of the one or more workflow items comprises a task associated with the preparation of a cadastral survey.

5. The method of claim 2, wherein the workflow management schedule is provided by a computer system at a location which is remote from and in network communication with a user.

6. The method of claim 2, wherein the step of comparing the one or more workflow items included on the workflow management schedule with workflow items included on a reference schedule comprises accessing, with the computer system, a database of reference schedules.

7. The method of claim 6, wherein the database of reference schedules comprises reference schedules derived from prior projects.

8. The method of claim 6, wherein the database of reference schedules comprises modeled schedules.

9. The method of claim 6, wherein the database of reference schedules comprises a remote database accessed by the computer system over a network.

10. The method of claim 2, further comprising defining, with the computer system, a scope of work associated with the necessary workflow item.

11. The method of claim 10, wherein the step of defining a scope of work associated with the workflow item comprises providing data associated with the workflow management schedule from the computer system to a separate scope calculation program configured to calculate a scope of work from the data.

12. The method of claim 11, wherein the separate scope calculation program is located remotely and is accessed by the computer system over a network.

13. The method of claim 10, wherein the step of defining a scope of work associated with the workflow item comprises accessing, with the computer system, a database of reference scopes of work.

14. The method of claim 13, wherein the database of reference scopes of work comprises reference scopes of work derived from prior projects.

15. The method of claim 13, wherein the database of reference scopes of work comprises modeled scopes of work.

16. The method of claim 13, wherein the database of reference scopes of work comprises a remote database accessed by the computer system over a network.

17. The method of claim 2, further comprising transferring the necessary workflow item from the computer system to schedules maintained by one or more personnel identified by the computer system as being associated with an execution of the necessary workflow item.

18. The method of claim 2, further comprising requesting, with the computer system, at least one of materials, equipment, or services associated with the necessary workflow item.

19. The method of claim 2, further comprising indicating on the workflow management schedule, with the computer system, the completion of at least a portion of the necessary workflow item.

20. A computer system comprising:
a processor; and
a computer readable medium in communication with the processor, the computer readable medium having encoded thereon a workflow management component to program the computer system to perform one or more operations, the workflow management component including a set of instructions executable by the processor, the set of instructions comprising:
instructions for providing a workflow management schedule including one or more workflow items;
instructions for comparing the one or more workflow items included on the workflow management schedule with workflow items included on a reference schedule;
instructions for identifying a necessary workflow item included on the reference schedule not included on the workflow management schedule; and
instructions for adding the necessary workflow item to the workflow management schedule.

21. An apparatus, comprising:
a non-transitory computer readable medium having encoded thereon a set of instructions executable by one or more computers to perform one or more operations, the set of instructions comprising:
instructions for providing a workflow management schedule including one or more workflow items;
instructions for comparing the one or more workflow items included on the workflow management schedule with workflow items included on a reference schedule;
instructions for identifying a necessary workflow item included on the reference schedule not included on the workflow management schedule; and
instructions for adding the necessary workflow item to the workflow management schedule.
